(19) United States
(12) Patent Application Publication
(10) Pub. No.: US 2012/0011429 A1
(43) Pub. Date: Jan. 12, 2012

(54) IMAGE PROCESSING APPARATUS AND IMAGE PROCESSING METHOD

(75) Inventors: Ryo Kosaka, Tokyo (JP); Reiji Misawa, Tokyo (JP); Tomotoshi Kanatsu, Tokyo (JP); Hidetomo Sohma, Yokohama-shi (JP)

(73) Assignee: CANON KABUSHIKI KAISHA, Tokyo (JP)

(21) Appl. No.: 13/176,944

(22) Filed: Jul. 6, 2011

(30) Foreign Application Priority Data
Jul. 8, 2010 (JP) 2010-156008

(51) Int. Cl. G06F 17/00

(52) U.S. Cl. 715/230

(57) ABSTRACT

An image processing apparatus successively designates each page of an input page image as a processing target, detects an anchor expression constituted by a specific character string, and associates a highlight position corresponding to the anchor expression with a link identifier. When the anchor expression and the link identifier are registered in a link configuration management table, if the same anchor expression is already registered in the table, the apparatus updates the table in such a way as to mutually associate the link identifiers of the same anchor expression. The apparatus generates page data of an electronic document based on a link identifier relating to a processing target page image and its highlight position and transmits the generated page data. The apparatus generates information usable to link the relevant link identifiers based on the link configuration management table, after completing the processing for all pages, and transmits the generated information.

### BACKGROUND OF THE INVENTION

1. Field of the Invention

The present invention relates to an image processing apparatus that can generate electronic document data including mutual link information attached thereto from a paper document or electronic document data. The present invention further relates to an image processing method, a computer program, and a computer-readable storage medium storing the computer program.

2. Description of the Related Art

A wide variety of documents, including an “object” and an “explanatory note (commentary sentence) for the object”, are conventionally used as paper documents or electronic documents. Examples of such documents include treatises, patent literatures, instruction books, and product catalogs. In this case, the “object” represents an independent region, such as “photo”, “line drawing”, and “table”, contained in each document. The “explanatory note (commentary sentence) for the object” represents a sentence that describes details about the above-described “object” in the text.

As an identifier that can specify an object, an expression such as “FIG. 1” (i.e., a drawing number) is generally used to indicate a correlation between the “object” and the “explanatory note for the object.” The identifier that correlates the “object” with the “explanatory note for the object”, such as “FIG. 1”, is referred to as an “anchor expression” in the following description. Further, in many cases, a simple explanatory note for an object and an anchor expression are present in the vicinity of the object itself. The explanatory note and the anchor expression are collectively referred to as “caption expressions.”

In general, a reader of such a document is required to confirm a correspondence relationship between a target “object” and an “explanatory note for the object” while checking an anchor expression in a text. If the document reader finds a sentence “FIG. 1 shows . . . ” in the text, the document reader searches for an object corresponding to “FIG. 1” in the document and then (i.e., after confirming the content of the object) returns to the previous position in the text to resume reading the document.

On the other hand, if the document reader finds an object accompanied by an anchor expression “FIG. 1” in a caption expression, the reader searches for a sentence that describes “FIG. 1” in the text. Then, the reader confirms the explanatory note and returns to the previous page to resume reading the document.

If the document is composed of a plurality of pages, it may be necessary for the reader to check a wider range spanning two or more pages to search for the object corresponding to “FIG. 1 shows . . . ” or the explanatory note corresponding to the object “FIG. 1” in the text. In other words, legibility becomes worse. In general, finding an explanatory note in a text is not so easy. The explanatory note may be present at a plurality of portions in the text. It may take a relatively long time for the reader to confirm all of them.

As discussed in Japanese Patent Application Laid-Open No. 11-066196, there is a conventional technique capable of optically reading a paper document and generating a document usable in various types of computers according to the purpose of use. More specifically, it is feasible to generate an electronic document with a hypertext that correlates each drawing with a drawing number. For example, if the reader clicks with a mouse on a “drawing number” in a text, a drawing corresponding to the “drawing number” can be displayed on a screen.

However, according to the technique discussed in Japanese Patent Application Laid-Open No. 11-066196, the link that can be provided is limited to only the link connecting a drawing number in the text to a corresponding object. No link is provided to connect the object to the drawing number in the text. Therefore, the following problems may arise.

(1) When an “object” is initially browsed, it takes a relatively long time to search for an “explanatory note for the object.”
(2) Although a corresponding “object” can be displayed after initially reading an “explanatory note for the object”, it is not so easy to find the previous position (e.g., paragraph number, row number, etc.) when the screen display of the “object” is closed to return to the “explanatory note for the object” after the browsing of the “object” is completed.
(3) It is not so easy to identify the position (e.g., page number, row number, etc.) of an “object” in a document (or page) when the screen display of the “object” is performed.

Further, even in a case where a text includes only one “object”, an “explanatory note for the object” may appear at different (a plurality of) portions in the text. In such a case, it is required to confirm the entire content of all pages to generate a hyperlink between a drawing and a drawing number. Hence, a large-size work memory is required if the data of all pages is temporarily held. In addition, when a processed document is output to an external apparatus, there will be a relatively long waiting time before the processing of all pages is completed. More specifically, outputting processed pages on a page-by-page basis in response to completion of analysis processing on each page is unfeasible. As a result, transfer efficiency becomes worse.

### SUMMARY OF THE INVENTION

According to an aspect of the present invention, an image processing apparatus includes an input unit configured to input a document including a plurality of page images; a region segmentation unit configured to divide each page image input by the input unit into attribute regions; a character recognition unit configured to execute character recognition processing on the regions divided by the region segmentation unit; a first detection unit configured to detect a first anchor expression constituted by a specific character string from a result of the character recognition processing executed by the character recognition unit on a text attribute region in the page image; a first identifier allocation unit configured to allocate a first link identifier to the first anchor expression detected by the first detection unit; a first graphic data generation unit configured to generate graphic data to be used to identify the first anchor expression detected by the first detection unit and associate the generated graphic data with the first link identifier allocated by the first identifier allocation unit; a first table updating unit configured to register the first link identifier and the first anchor expression in a link configuration management table while associating them with each other and, if an anchor expression similar to the first anchor expression is already registered in the link configuration management table, configured to update the link configuration management table in such a way as to mutually associate the link identifiers of the same anchor expression; a second detection unit configured to detect a second anchor expression constituted by a specific character string from a result of the character recognition processing executed by the character recognition unit on a caption region accompanying an object in the page image; a second identifier allocation unit configured to allocate a second link identifier to the object accompanied by the caption region where the second anchor expression is detected; a second graphic data generation unit configured to generate graphic data to be used to identify the object accompanied by the caption region where the second anchor expression is detected and associate the generated graphic data with the second link identifier allocated by the second identifier allocation unit; a second table updating unit configured to register the second link identifier and the second anchor expression in the link configuration management table while associating them with each other and, if an anchor expression similar to the second anchor expression is already registered in the link configuration management table, configured to update the link configuration management table in such a way as to mutually associate the link identifiers of the same anchor expression; a page data generation unit configured to generate page data of an electronic document for the page image, using the first link identifier, the first graphic data, the second link identifier, and the second graphic data; a first transmission unit configured to transmit the page data of the electronic document generated by the page data generation unit; a control unit configured to successively designate each page of the page image input by the input unit as a processing target and control processing repetitively executed by the region segmentation unit, the character recognition unit, the first detection unit, the first identifier allocation unit, the first graphic data generation unit, the first table updating unit, the second detection unit, the second identifier allocation unit, the second graphic data generation unit, the second table updating unit, the page data generation unit, and the first transmission unit; and a second transmission unit configured to generate link configuration information to be used to link the first link identifier with the second link identifier included in the electronic document based on the link configuration management table updated by the first table updating unit and the second table updating unit, and configured to transmit the generated link configuration information.

According to another aspect of the present invention, an image processing apparatus includes an input unit configured to input a document including a plurality of page images; a region segmentation unit configured to divide each page image input by the input unit into attribute regions; a character recognition unit configured to execute character recognition processing on the regions divided by the region segmentation unit; a detection unit configured to detect an anchor expression constituted by a specific character string from a result of the character recognition processing executed by the character recognition unit; an identifier allocation unit configured to allocate a link identifier to the anchor expression detected by the detection unit; a generation unit configured to generate data that associates a highlight position to be determined based on the anchor expression with the link identifier; a table updating unit configured to register the anchor expression and the link identifier in a link configuration management table while associating them with each other and, if an anchor expression similar to the anchor expression is already registered in the link configuration management table, configured to update the link configuration management table in such a way as to mutually associate the link identifiers of the same anchor expression; a first transmission unit configured to generate page data of an electronic document for the page image, based on the link identifier and the highlight position, and transmit the generated page data; a control unit configured to successively designate each page of the page image input by the input unit as a processing target and control processing repetitively executed by the region segmentation unit, the character recognition unit, the detection unit, the identifier allocation unit, the generation unit, the table updating unit, and the first transmission unit; and a second transmission unit configured to generate link configuration information to be used to link the link identifiers included in the electronic document based on the link configuration management table updated by the table updating unit, and configured to transmit the generated link configuration information.

According to exemplary embodiments of the present invention, a mutual link between an “object” and an “explanatory note for the object” in the text can be automatically generated on a page-by-page basis using an input electronic document including a plurality of pages. In addition, an electronic document including multiple pages can be generated. The relationship between the “object” and the “explanatory note for the object” can be easily checked referring to the mutual link. The legibility can be improved. Further, when a document image of a plurality of pages is transmitted to a personal computer, the mutual link can be automatically generated even in a case where a page on which the “object” is present is different from a page including the “explanatory note for the object.” A large-scale work memory capable of holding the data of all pages is not required because the processing can be performed on a page-by-page basis. Further, transmitting the electronic document data on a page-by-page basis is useful to improve the transfer efficiency.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an image processing system according to an exemplary embodiment of the present invention.

FIG. 2 is a block diagram illustrating a multifunction peripheral (MFP) according to an exemplary embodiment of the present invention.

FIG. 3 is a block diagram illustrating an example configuration of a data processing unit according to an exemplary embodiment of the present invention.

FIG. 4 is a block diagram illustrating an example configuration of a link processing unit according to an exemplary embodiment of the present invention.

FIGS. 5A to 5C illustrate a result of region segmentation processing performed on input image data according to an exemplary embodiment of the present invention.

FIG. 6 illustrates an example of electronic document data that can be generated from input image data according to an exemplary embodiment of the present invention.

FIG. 7 is a flowchart illustrating the entire processing according to a first exemplary embodiment of the present invention.

FIG. 8 is a flowchart illustrating link processing performed on a page-by-page basis according to the first exemplary embodiment of the present invention.

FIGS. 9A to 9D illustrate examples of link configuration management tables that can be generated according to the first exemplary embodiment of the present invention.

FIGS. 10A to 10D illustrate a plurality of example page images and processing results according to the first exemplary embodiment of the present invention.

FIG. 11 illustrates a configuration of electronic document data according to the first exemplary embodiment of the present invention.

FIG. 12 is a flowchart illustrating example processing that can be performed by a reception side apparatus according to the first exemplary embodiment of the present invention.

FIGS. 13A to 13C illustrate an example operation that can be performed by an application according to the first exemplary embodiment of the present invention.

FIG. 14 is a flowchart illustrating example processing that can be performed by the application according to the first exemplary embodiment of the present invention.

FIG. 15 is a flowchart illustrating example processing according to a fourth exemplary embodiment of the present invention.

### DESCRIPTION OF THE EMBODIMENTS

Various exemplary embodiments, features, and aspects of the invention will be described in detail below with reference to the drawings.

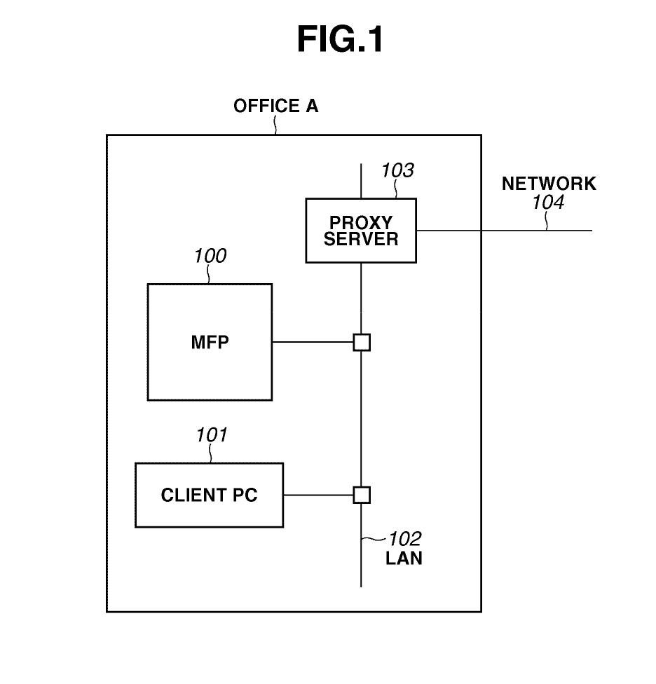

FIG. 1 is a block diagram illustrating a configuration of an image processing system according to an exemplary embodiment of the present invention.

In FIG. 1, a multifunction peripheral (MFP) 100 is connected to a local area network (LAN) 102 established in an office A. The MFP 100 has the capability of realizing a plurality of types of functions (e.g., a copy function, a print function, and a transmission function). The LAN 102 is connected to a network 104 via a proxy server 103. A client personal computer (PC) 101 can receive transmission data from the MFP 100 via the LAN 102 and can use the functions that can be realized by the MFP 100.

For example, the client PC 101 can transmit print data to the MFP 100 and can instruct the MFP 100 to print a print product based on the received print data. The configuration illustrated in FIG. 1 is a mere example. For example, two or more offices, each having components similar to that of the office A, can be connected to the network 104. Further, the network 104 is typically the Internet, and can be another LAN or a wide area network (WAN), or can be a telephone circuit, a dedicated digital circuit, an automated teller machine (ATM) or frame relay circuit, a communication satellite circuit, a cable television circuit, a data broadcasting wireless circuit, or any other communication network.

Any type of network, which is usable for data transmission/reception, can be used as the network 104. Further, the client PC 101 and the proxy server 103 have various components, such as a central processing unit (CPU), a random access memory (RAM), a read only memory (ROM), a hard disk, an external storage device, a network interface, a display device, a keyboard, and a mouse, which are standard components installed on a general computer.

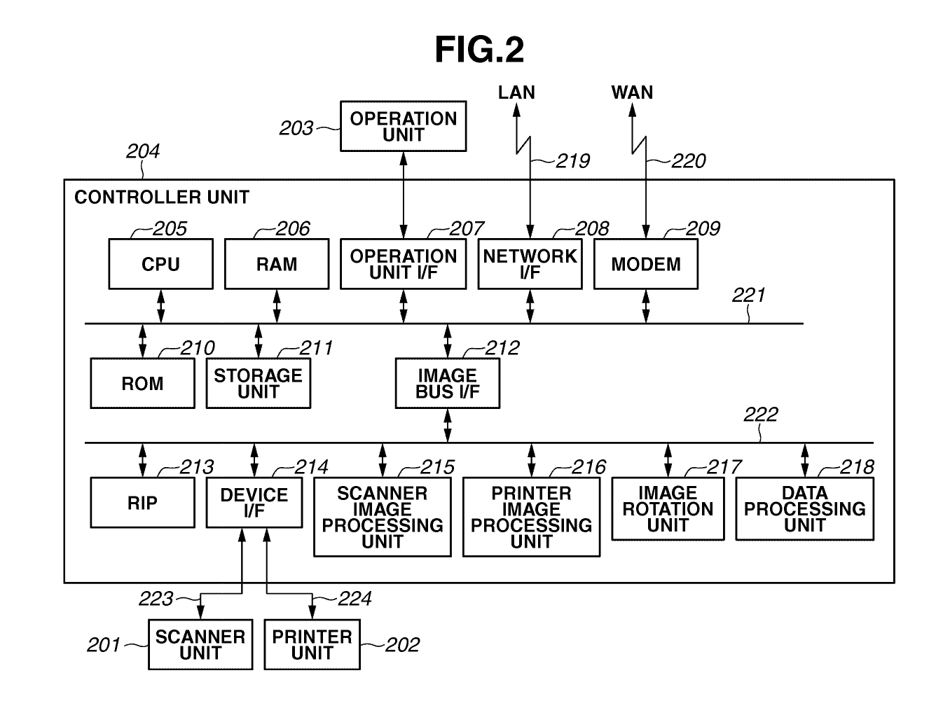

FIG. 2 illustrates a detailed configuration of the MFP 100, which is functionally operable as an image processing apparatus according to the present exemplary embodiment. The MFP 100 illustrated in FIG. 2 includes a scanner unit 201 that is functionally operable as an image input device, a printer unit 202 that is functionally operable as an image output device, a controller unit 204 including a central processing unit (CPU) 205, and an operation unit 203 that is functionally operable as a user interface.

The controller unit 204 is connected to the scanner unit 201, the printer unit 202, and the operation unit 203. The controller unit 204 can access an external device via a local area network (LAN) 219 or a public telephone line (WAN) 220, i.e., a general telephone circuit network, to input and output image information and device information.

The CPU 205 can control each functional unit included in the controller unit 204. A random access memory (RAM) 206 can be accessed by the CPU 205 and is usable as a system work memory when the CPU 205 operates. The CPU 205 is also an image memory in which image data can be temporarily stored.

A read only memory (ROM) 210 is a boot ROM that stores a system boot program. A storage unit 211 is a hard disk drive that stores system control software and image data. An operation unit interface (I/F) 207 is an interface unit that controls each access to the operation unit (UI) 203. Image data can be output to the operation unit 203 via the operation unit I/F 207 to display the image data on a screen of the operation unit 203.

Further, when a user of the image processing apparatus inputs information via the operation unit 203, the operation unit I/F 207 can transmit the input information to the CPU 205. A network I/F 208 can connect the image processing apparatus to the LAN 219 to input and output packet format information. A modem 209 can connect the image processing apparatus to an external device via the WAN 220 and can perform data demodulation/modulation processing to input and output information. The above-described functional devices are mutually accessible via a system bus 221.

An image bus I/F 212 is a bus bridge disposed between the system bus 221 and an image bus 222. The image bus 222 has the capability of realizing high-speed transfer of image data. The image bus I/F 212 can transform a data structure of the image data. The image bus 222 is, for example, a PCI bus or an IEEE1394 bus. The following functional devices are mutually connected via the image bus 222.

A raster image processor (RIP) 213 can realize so-called rendering processing. More specifically, the RIP 213 analyzes a page description language (PDL) code and rasterizes a bitmap image having a designated resolution. When the RIP 213 rasterizes the bitmap image, the RIP 213 determines an attribute for each pixel or each region and adds attribute information that represents a determination result. This processing is referred to as “image region determination processing.” Through the image region determination processing, attribute information indicating the type (attribute) of an object, such as “text”, “line”, “graphics”, and “image”, is allocated to each pixel or each region.

A device I/F 214 can connect the scanner unit 201 (i.e., the image input device) to the controller unit 204 via a signal line 223. Further, the device I/F 214 can connect the printer unit 202 (i.e., the image output device) to the controller unit 204 via a signal line 224. The device I/F 214 can perform synchronous/asynchronous conversion processing on image data. A scanner image processing unit 215 is configured to perform correction, modification, and editing processing on input image data.

A printer image processing unit 216 is configured to perform correction and resolution conversion processing on print output image data to be output to the printer unit 202 according to the printer unit 202. An image rotation unit 217 is configured to rotate input image data and output upright image data. A data processing unit 218 is described in detail below.

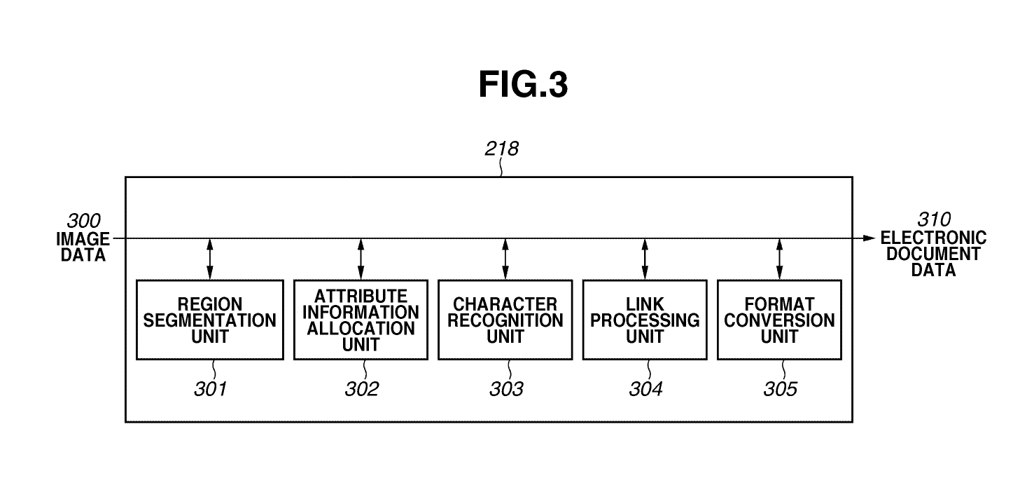

Next, an example configuration and operations of the data processing unit 218 illustrated in FIG. 2 are described below with reference to FIG. 3. The data processing unit 218 includes a region segmentation unit 301, an attribute information allocation unit 302, a character recognition unit 303, a link processing unit 304, and a format conversion unit 305. The data processing unit 218, for example, receives image data 300 scanned by the scanner unit 201 and causes respective processing units 301 to 305 to process the input image data 300. Then, the data processing unit 218 outputs electronic document data 310.

The region segmentation unit 301 is configured to receive image data scanned by the scanner unit 201 illustrated in FIG. 2 or image data (document image) stored in the storage unit 211. The region segmentation unit 301 divides the input image data into respective regions, such as character, photo, drawing, and table, disposed on a page.

In this case, a conventionally known region extraction method (region segmentation method) can be used. An example of the region extraction method (region segmentation method) includes binarizing an input image to generate a binary image and lowering the resolution of the binary image to generate a thinned-out image (reduced image). For example, to generate a thinned-out image of 1/(M×N), the binary image is divided into a plurality of blocks each including M×N pixels and, if a black pixel is present in the M×N pixels, a corresponding reduced pixel becomes a black pixel. If no black pixel is present, a corresponding reduced pixel becomes a white pixel.

The method further includes extracting a portion where black pixels are continuously arranged (i.e., continuous black pixels) in the thinned-out image and generates a rectangle that circumscribes the continuous black pixels.

In this case, if a plurality of rectangles each having a size similar to that of a character image are disposed continuously, or if similar rectangles each having a vertical or horizontal length comparable to that of a character image (rectangles of continuously connected black pixels) are disposed continuously in the vicinity of a short side, there is a higher possibility that a character image of a single character row is present. In this case, a rectangle representing one character row can be obtained by connecting the rectangles.

If two or more rectangles each representing a single character row are similar in the length of the short side and are arranged at equal intervals in the column direction, there is a higher possibility that an assembly of these rectangles is a text portion. Therefore, these rectangles can be integrally extracted as a text region. Further, a photo region, a drawing region, and a table region can be extracted as continuous black pixels having a size larger than that of a character image.

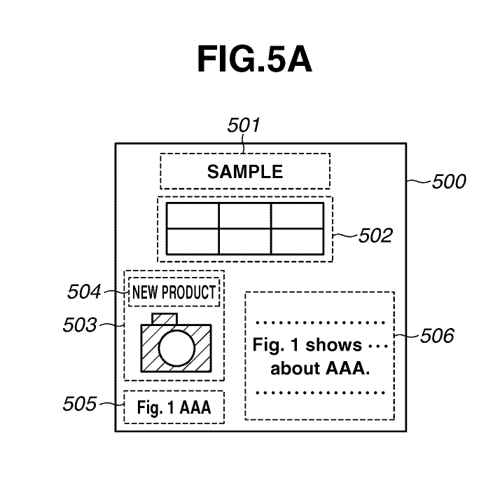

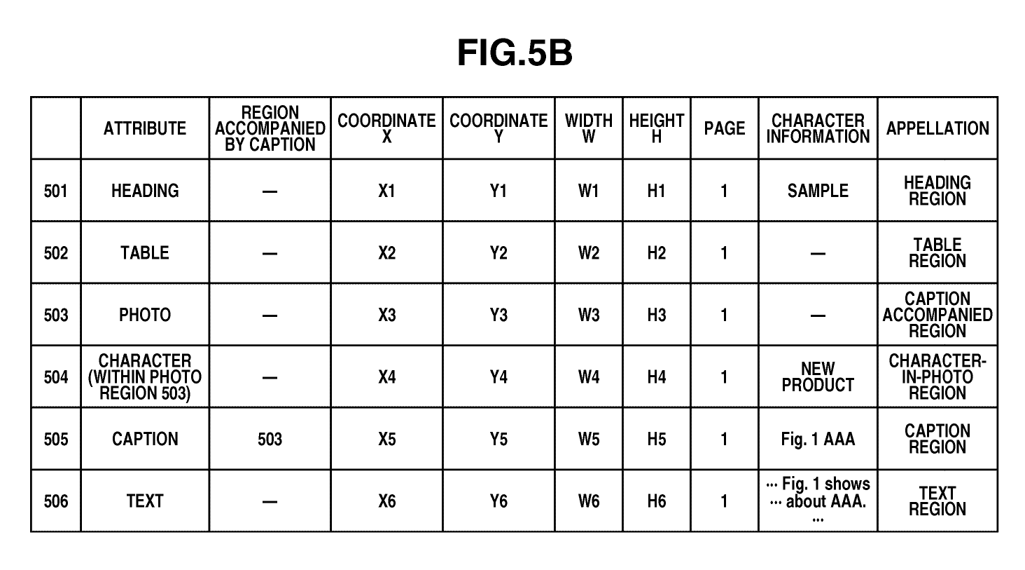

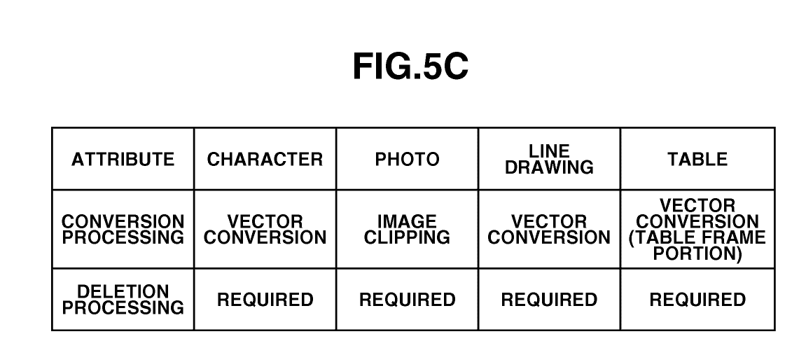

As a result, for example, image data 500 illustrated in FIG. 5A can be divided into a plurality of regions 501 to 506. The attribute of each region can be determined based on its size or its aspect ratio, or based on a density of black pixels or a contour tracing result of white pixels included in the continuous black pixels, as described below.

The attribute information allocation unit 302 is configured to add an attribute to each region divided by the region segmentation unit 301. In the present exemplary embodiment, an example processing operation that can be performed by the attribute information allocation unit 302 is described below based on an example of the input image data 500 illustrated in FIG. 5A.

The attribute information allocation unit 302 allocates an attribute “text” (i.e., a text attribute) to the region 506, because the region 506 includes a certain number of characters or a certain number of rows that constitute apart of the page and because the region 506 is constituted by continuous character strings in such away as to maintain a style of one text (e.g., number of characters, number of rows, and paragraphs).

The attribute information allocation unit 302 determines whether a remaining region includes a rectangle whose size is similar to that of a character image. In particular, regarding a region including character images, rectangles of the character images periodically appear in the region. Therefore, the attribute information allocation unit 302 can identify a region that includes characters.

As a result, the attribute information allocation unit 302 allocates an attribute “character” to each of the region 501, the region 504, and the region 505 because these regions include characters. However, these regions 501, 504, and 505 do not have any style of a text (e.g., number of characters, number of rows, and paragraph) and are different from the above-described text region.

On the other hand, the attribute information allocation unit 302 determines a remaining region as a “noise” if the size of the region is very small. Further, when white pixel contour tracing is applied to the internal region of continuous black pixels having smaller pixel density, the attribute information allocation unit 302 identifies the concerned region as a “table” if the white pixel contour circumscribing rectangles are orderly arranged and as a “line drawing” if the rectangles are not orderly arranged.

The attribute information allocation unit 302 identifies another region having a higher value in pixel density as a picture or a photo, and allocates an attribute “photo” to the identified region. The region to which the attribute “table”, “line drawing”, or “photo” is allocated corresponds to the above-described “object” and has an attribute other than “character.”

Further, a character region may not be determined as a text and may be present in the vicinity of an object region (e.g., above or beneath the object region) to which the attribute “table”, “line drawing”, or “photo” is allocated. In this case, the attribute information allocation unit 302 identifies the object region as a character region describing the “table”, “line drawing”, or “photo” region.

Then, the attribute information allocation unit 302 allocates an attribute “caption” to the character region having been not identified as the text. The attribute information allocation unit 302 stores the caption region in such a manner that an object region (e.g., “table”, “line drawing”, or “photo” object) accompanied by the “caption” region can be specified based on the stored information.

More specifically, a region to which the attribute “caption” is allocated (hereinafter, referred to as a “caption region”) is stored in association with an object region that is accompanied by the “caption” (hereinafter, referred to as a “caption accompanied object”). For example, as illustrated in FIG. 5B, in a “region accompanied by caption” field, the region 505 (caption region) is associated with the “region 503.”

Further, the attribute information allocation unit 302 allocates an attribute “heading” to a character region if a character size thereof is larger than that of a character image of the text region and if the position thereof is different from the column setting of the text region. Further, the attribute information allocation unit 302 allocates an attribute “sub-heading” to a region if the character size thereof is larger than a character image of the text region and if it is positioned on the upper side of the column setting of the text region.

Further, the attribute information allocation unit 302 allocates an attribute “page” (or “page header” or “page footer”) to a region if the region is constituted by character images whose size is equal to or smaller than that of the character images of the text region and if the region is present in a lower-end portion or in an upper-end portion of the page that constitutes the image data. Further, the attribute information allocation unit 302 allocates an attribute “character” to a region that has been identified as a character region but has not been identified as “text”, “heading”, “sub-heading”, “caption”, or “page.”

If the above-described attribute information allocation processing is performed on the image data illustrated in FIG. 5A, the attribute “heading” is allocated to the region 501, the attribute “table” is allocated to the region 502, and the attribute “photo” is allocated to the region 503. Further, the attribute “character” is allocated to the region 504, the attribute “caption” is allocated to the region 505, and the attribute “text” is allocated to the region 506. As the attribute “caption” is allocated to the region 505, the region 503 is associated, as a caption accompanied object, with the region 505.

Further, the region 503 to which the attribute “photo” is allocated corresponds to an “object” in the present exemplary embodiment. The region 506 to which the attribute “text” is allocated corresponds to the above-described “explanatory note for the object” because the region 506 includes an anchor expression “FIG. 1”. The allocation of the attribute by the attribute information allocation unit 302 is storing, in the storage unit 211, the identified attribute in association with each region divided by the region segmentation unit 301, for example, as apparent from the data table illustrated in FIG. 5B.

The character recognition unit 303 is configured to execute conventionally known character recognition processing on each region including a character image (i.e., each region having the attribute “character”, “text”, “heading”, “sub-heading”, or “caption”), and is configured to store the obtained result as character information in the storage unit 211 while associating it with a target region. For example, as illustrated in FIG. 5B, character information that represents a character recognition processing result is described in the “character information” field of respective regions 501, 504 to 506.

Information extracted by the region segmentation unit 301, the attribute information allocation unit 302, and the character recognition unit 303 as described above, such as region attribute information (the position and the size of each region), page information, and character recognition result information (character code information), are stored in the storage unit 211 while associating them with each region.

For example, FIG. 5B illustrates an example of the data table stored in the storage unit 211 in a case where the image data 500 illustrated in FIG. 5A is processed. Although not described in detail in FIGS. 5A and 5B, it is desired to allocate an attribute “character in table” to a character image region of a region whose attribute is “table” and perform character recognition processing on the character image region, and if a processing result is obtained, further store the result as character information. The region 504 is a region included in a photo or a drawing, as illustrated FIG. 5B. Therefore, an attribute “within photo region 503” is allocated to the region 504.

The link processing unit 304 is configured to generate link information that links a caption accompanied object (i.e., a region having an attribute “table”, “line drawing”, “photo”, or “illustration”) detected by the attribute information allocation unit 302 with an “explanatory expression in the text including an anchor expression.” Then, the link processing unit 304 stores the generated link information in the storage unit 211. The link processing unit 304 is described in detail below.

The format conversion unit 305 is configured to convert the input image data 300 into the electronic document data 310 based on the information obtained by the region segmentation unit 301, the attribute information allocation unit 302, the character recognition unit 303, and the link processing unit 304. An example of the file format for the electronic document data 310 is SVG, XPS, PDF, or OfficeOpenXML.

The converted electronic document data 310 is stored in the storage unit 211 or transmitted, via the LAN 102, to the client PC 101. An application (e.g., Internet Explorer, Adobe Reader, or MS Office) installed on the client PC 101 enables a document user to browse the electronic document data 310. An example operation for browsing the electronic document data 310 with the use of an application is described in detail below.

The electronic document data 310 includes page display information (including images to be displayed) that can be expressed using graphics and content information (e.g., link information) that can be expressed using a meaning description including characters.

The processing by the format conversion unit 305 can be roughly classified into two, one of which includes performing filtering (such as flattening, smoothing, edge enhancement, color quantization, and binarizing) processing on each image region to convert the image data of each region to have a designated format that can be stored in the electronic document data 310. For example, the format conversion unit 305 converts the image data of a region having the attribute “character”, “line drawing”, or “table” into vector path description graphics data (vector data) or bitmap description graphics data (e.g., JPEG data).

A conventionally known vectorization technique is employable as a technique capable of converting the image data into vector data. Then, the format conversion unit 305 converts the vector data into the electronic document data 310 in association with region information (e.g., position, size, and attribute), character-in-region information, and link information stored in the storage unit 211.

Further, the above-described format conversion unit 305 performs conversion processing on each region according to a method that is variable depending on the attribute of the region. For example, vector conversion processing is suitable for a monochrome image (or its equivalent) of a character or a line drawing, but is not suitable for a gradational image region such as a photo region.

As described above, to perform appropriate conversion processing according to the attribute of each region, it is desired to set a correspondence table illustrated in FIG. 5C beforehand and perform the conversion processing with reference to the correspondence table. For example, according to the correspondence table illustrated in FIG. 5C, the format conversion unit 305 performs vector conversion processing on each region having the attribute “character”, “line drawing”, or “table” and image clipping processing on each region having the attribute “photo.”

Further, in the correspondence table illustrated in FIG. 5C, the necessity of performing processing for deleting pixel information of a corresponding region from the image data 300 is stored in association with each attribute. For example, according to the correspondence table illustrated in FIG. 5C, the format conversion unit 305 performs the deletion processing when a region having the attribute “character” is converted into vector path description data.

Hence, on the image data 300, the format conversion unit 305 performs processing for marking out the pixel corresponding to a portion encircled by the converted vector path with a peripheral color. Similarly, when a region having the attribute “photo” is segmented as an image part of a rectangle, the format conversion unit 305 performs mark-out processing on a partial region of the image data 300 corresponding to the segmented region with a peripheral color.

As one of the effects obtained by the above-described deletion processing, the image data 300 can be used as “background” image part data after the processing for each region is completed (i.e., after the mark-out processing is terminated). A portion (e.g., background pixels included in the image data 300) other than the regions divided through the region segmentation processing may remain in the above-described background image data (i.e., a background image).

The description of the electronic document data 310 is performed in such a way as to superimpose the graphics data (a foreground image) obtained through the vector conversion processing or the image clipping processing performed by the format conversion unit 305 on background image part data (i.e., a background image). Thus, it becomes feasible to constitute non-redundant graphics data without losing the information of background pixels (a background color).

Hence, the processing according to the present exemplary embodiment includes performing binary image clipping processing and performing processing for deleting pixels from the image data 300 on each character region having the attribute “character.” The processing according to the present exemplary embodiment may not include performing the vectorization processing and the image clipping processing on each region having other attribute.

More specifically, pixels other than the processing target (i.e., in-region pixel information having the attribute “photo”, “line drawing”, or “table”) remain in the background image part data. Therefore, the processing according to the present exemplary embodiment includes superimposing the “character” image part on the background image.

Further, it is useful to prepare a plurality of correspondence tables (see FIG. 5C) beforehand so that an appropriate one of the tables can be selected according to the purpose of use of the electronic document data 310 to be output or considering the content of an electronic document. For example, the output based on the correspondence table illustrated in FIG. 5C is excellent in enlarged or reduced image quality because most of the object is converted into vector path description data, and can be reused by a graphic editor.

Further, as another generation of the correspondence table, it is feasible to reproduce a high-quality character image portion by converting a character image into binary images independently for each character color and reversibly compressing the generated binary images. Further, it is feasible to increase a rate of data size compression by performing JPEG compression on the remaining portion as a background image. This is suitable for a data generation of a character image that is easily readable even when it is highly compressed. The electronic document data can be appropriately generated by selecting one of the above-described generation methods.

FIG. 6 illustrates an example of the electronic document data 310 that can be generated by the data processing unit 218. The example illustrated in FIG. 6 is described according to a Scalable Vector Graphics (SVG) format and can be obtained when the image data 500 illustrated in FIG. 5A is processed based on the data table (FIG. 5B) stored in the storage unit 211. Although the present exemplary embodiment is described based on the SVG format, the data format is not limited to the SVG format and can be any one of PDF, XPS, Office Open XML, and other PDL formats.

In an electronic document data description 600 illustrated in FIG. 6, descriptions 601 to 606 are descriptions of the graphics corresponding to the regions 501 to 506 illustrated in FIG. 5A. The description 601 and the descriptions 604 to 606 are example descriptions for a character drawing using character codes. The description 602 is an example vector path description for the frame of a vector converted table. The description 603 is an example description for a photo image to be pasted and having been subjected to the clipping processing.

The examples illustrated in FIG. 5B and FIG. 6 include portions described using symbols, such as coordinate values X1 and Y1, which are practically replaced by numerical values. Further, a description 607 is an example description for the link information. The description 607 includes two descriptions 608 and 609. The description 608 is information relating to a link from a “caption accompanied object” to an “explanatory expression in the text.”

A description 610 is a link identifier, which is associated with the caption accompanied object indicated by the description 603 and a graphic data region indicated by a description 611. A description 612 is action information relating to an operation to be performed in a case where a document reader browses the electronic document data 310 with an application. The action information indicates a display operation to be performed on the application side in response to a pressing (or selection) of a graphic data region indicated by the description 611.

The description 609 is information relating to a link from the “explanatory expression in the text” to the “caption accompanied object.” Descriptions 613 to 615 are similar to the descriptions 610 to 612.

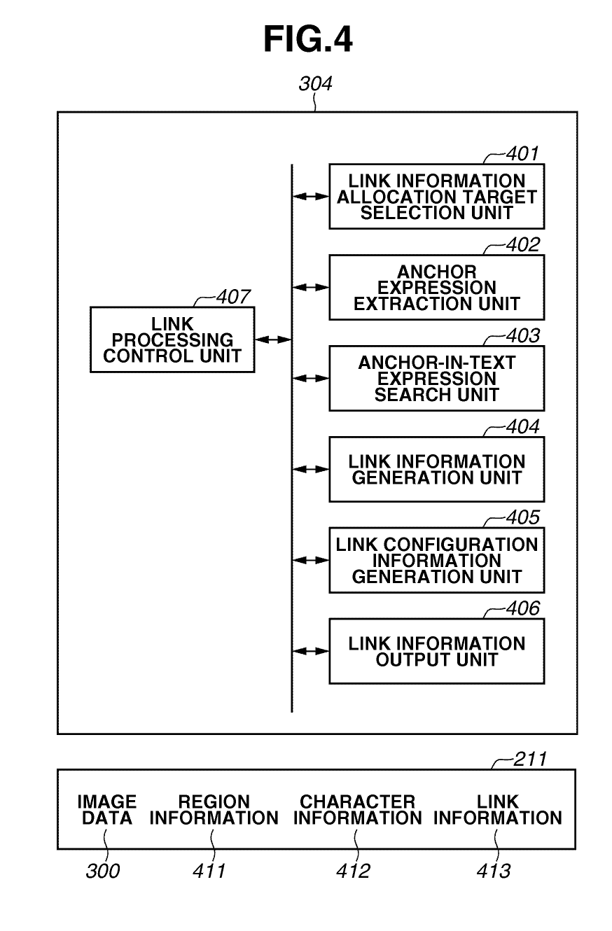

FIG. 4 is a block diagram illustrating an example configuration of the link processing unit 304. An example processing content of the link processing unit 304 is described below.

A link information allocation target selection unit 401 is configured to select a caption accompanied object as a target object to be subjected to the link information generation processing performed for input image data.

An anchor expression extraction unit 402 is configured to analyze character information in a caption region accompanying the object selected by the link information allocation target selection unit 401, and is configured to extract an anchor expression (e.g., “FIG. 1”, “FIG. 1”, etc.) from the analyzed character information. If any anchor expression is found, the anchor expression extraction unit 402 extracts the corresponding portion of the character information as an anchor expression and the remaining portion as a caption expression.

Further, if character code characteristics and dictionaries are usable, the anchor expression extraction unit 402 can exclude a meaningless character string (e.g., a row of meaningless symbols). This is effective to eliminate any error in the character recognition. For example, it becomes feasible to prevent a decoration, a division line, or any image that appears along the boundary of a text portion of a document from being erroneously interpreted as a character.

Further, to extract an anchor expression, it is useful to store multilingual character string patterns (e.g., drawing numbers) and error recognition patterns in the corresponding character recognition in a dictionary, because the anchor expression extraction accuracy can be improved and anchor expression characters can be corrected.

Further, the anchor expression extraction unit 402 can perform similar processing on caption expressions. More specifically, the anchor expression extraction unit 402 can perform analysis in natural language processing and can correct error recognitions in the character recognition. For example, the anchor expression extraction unit 402 can be configured to correct and exclude symbols and character decorations that appear along the boundary between anchor expressions or at the head or tail thereof.

An anchor-in-text expression search unit 403 is configured to search for all specific character strings (e.g., “Fig.”, “Figure”, etc.) of anchor expression that may be extracted through the anchor expression extraction processing performed by the anchor expression extraction unit 402 from character information included in each text region of a document, and is also configured to detect them as anchor expression candidates in the text corresponding to the object.

Further, the anchor-in-text expression search unit 403 can additionally detect, as an object explanatory expression candidate, an explanatory expression in the text that includes an anchor expression and explains the object. In the present exemplary embodiment, to realize a high-speed search, it is feasible to generate a search index. In this case, a conventionally known index generation/search technique is employable to generate the index and realize the high-speed search.

Further, specific character strings of a plurality of anchor expressions can be searched in a batch fashion to realize the high-speed search. Moreover, a multilingual character string pattern (e.g., a drawing number) and an error recognition pattern in the corresponding character recognition can be stored for an explanatory expression in the text. The stored information can be used to improve the search accuracy and provide a correction function.

A link information generation unit 404 is configured to generate link information that associates the caption accompanied object selected by the link information allocation target selection unit 401 with the anchor expression candidate and the explanatory expression candidate in the text that are searched and extracted by the anchor-in-text expression search unit 403. The link information includes link operation trigger, link action setting, and link configuration information, which are described in detail below.

In the present exemplary embodiment, the link information generation unit 404 generates a trigger and a link action setting, as link information from the “caption accompanied object” to an “anchor expression and an object explanatory expression that is possibly described in the text” or link information from the above-described “anchor expression candidate and the explanatory expression candidate in the text” to an “object that is possibly inserted into the document.” The link information is imperfect, when initially generated, because its link destination information is not yet determined.

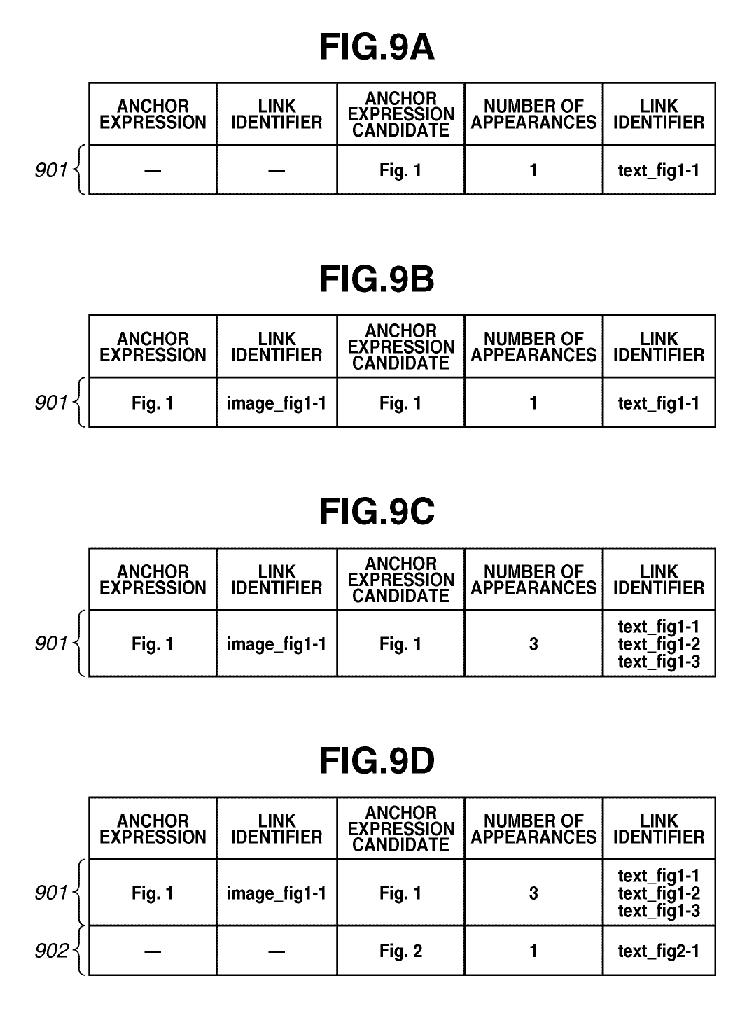

A link configuration information generation unit 405 is configured to generate and update link configuration management tables illustrated in FIGS. 9A to 9D that are usable to accumulate the link configuration information, such as link identifier, cumulative number of appearances, and link destination information, when the link information is generated by the above-described link information generation unit 404.

A link information output unit 406 is configured to collect the link configuration information generated by the link configuration information generation unit 405 and format the collected link configuration information so as to be output to the format conversion unit 305. The format conversion unit 305 can generate the electronic document data 310 based on the collected link configuration information.

A link processing control unit 407 is configured to entirely control the link processing unit 304. As a main role, the link processing control unit 407 distributes each region of the image data 300 together with region information 411 (e.g., position, size, and attribute information associated with each region) and character-in-region information 412 stored in the storage unit 211 illustrated in FIG. 2, to an appropriate one of the processing units 401 to 406.

Further, if any information is received from one of the processing units 401 to 406, the link processing control unit 407 performs control for sending the received information to an appropriate processing unit. The region information 411 and the character information 412 have a format of the data table (see FIG. 5B), which is associated with each region divided from the image data 300 by the region segmentation unit 301, and are stored in the storage unit 211.

An example operation that can be performed by each portion (each of the processing units 401 to 407 illustrated in FIG. 4) of the link processing unit 304 is described in detail below with reference to actual processing.

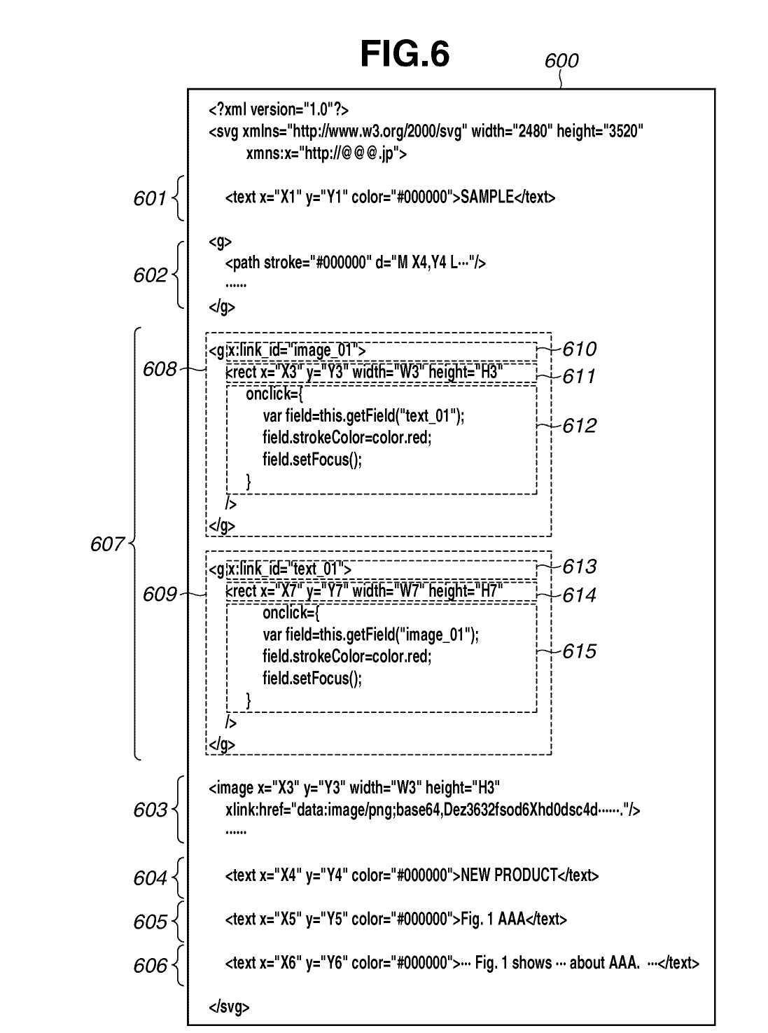

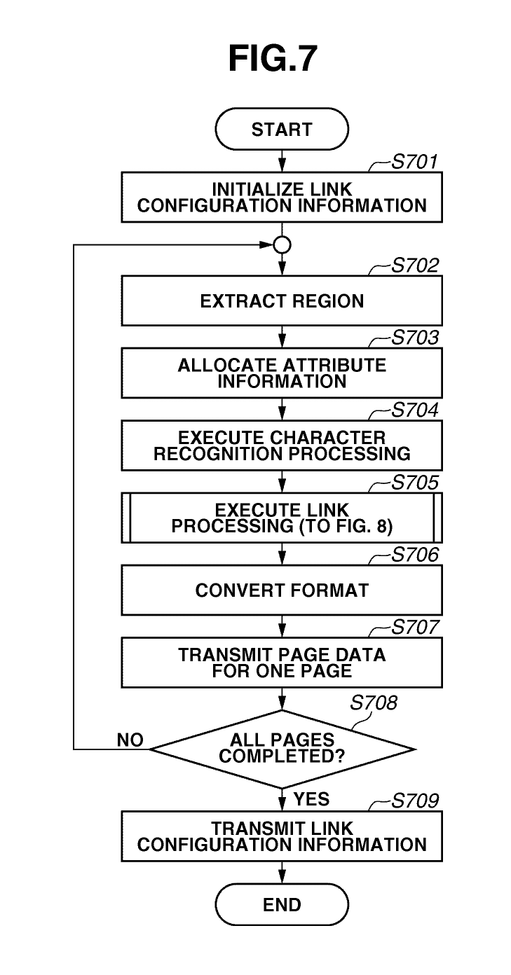

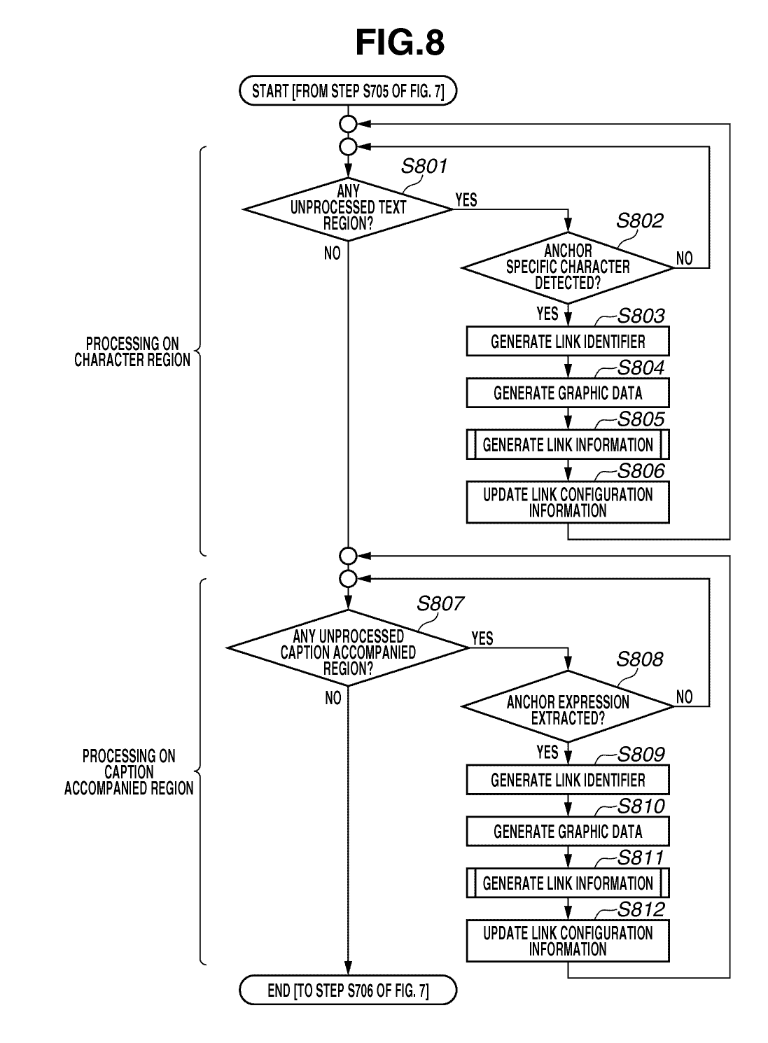

Next, the entire processing that can be performed by the image processing system according to the first exemplary embodiment is described below with reference to a flowchart illustrated in FIG. 7.

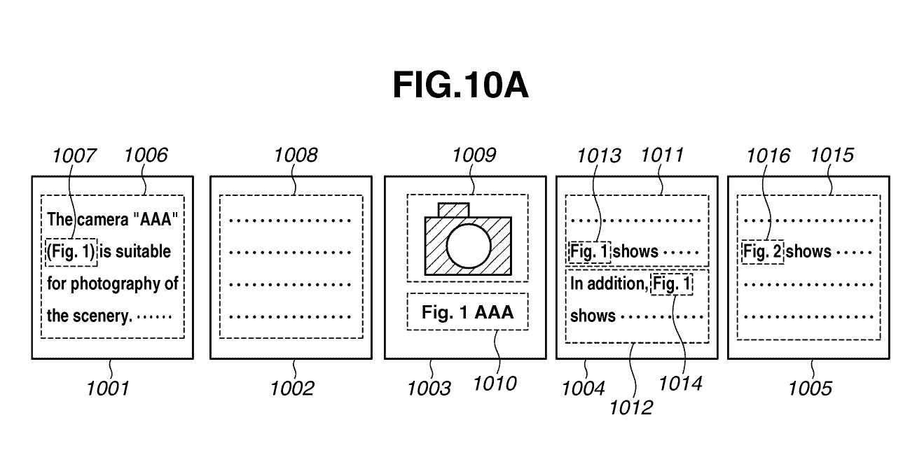

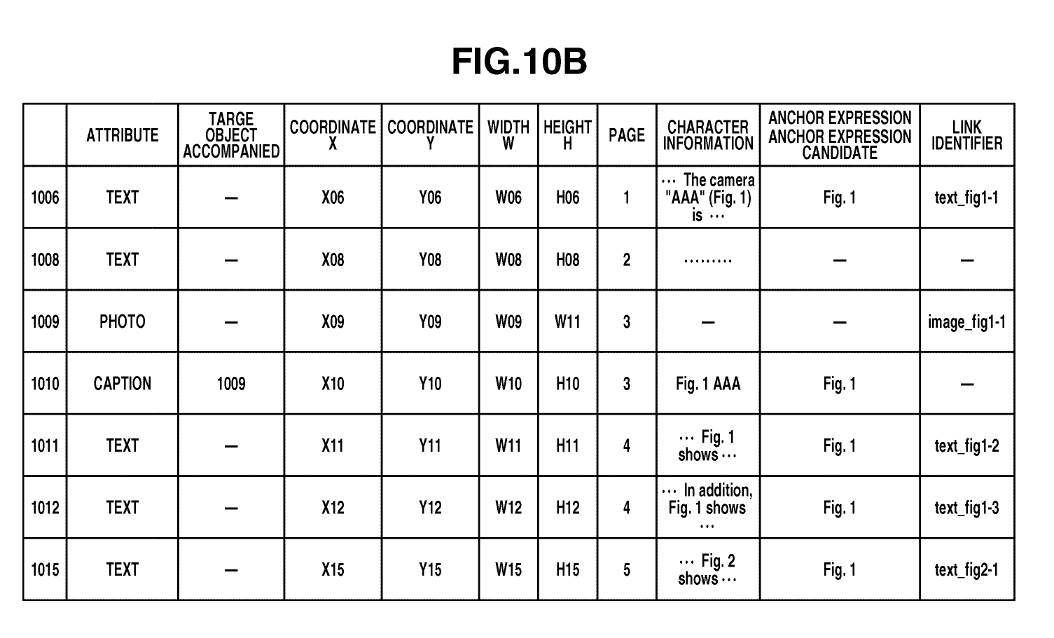

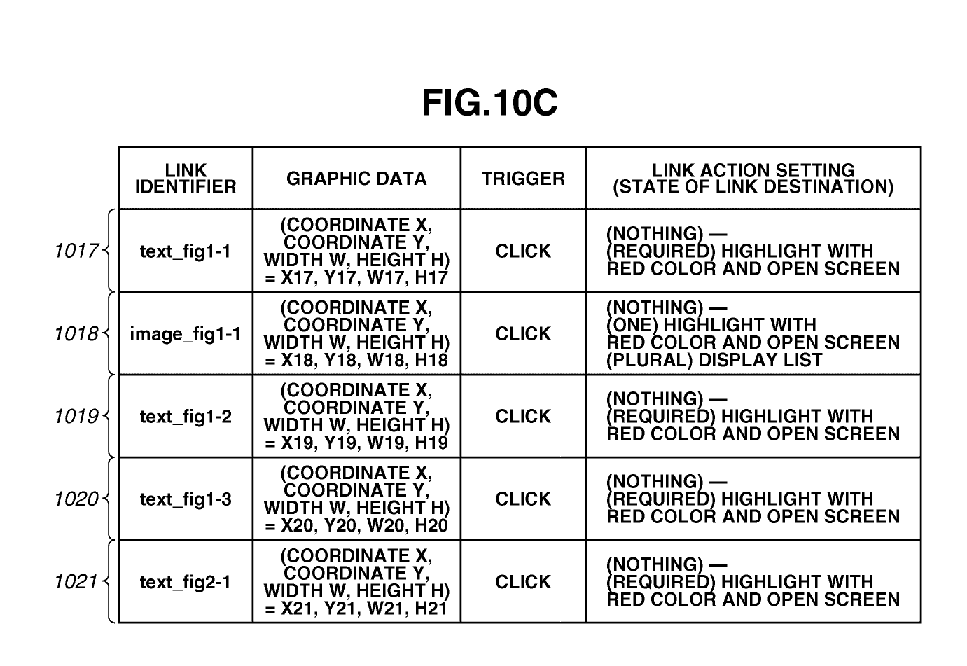

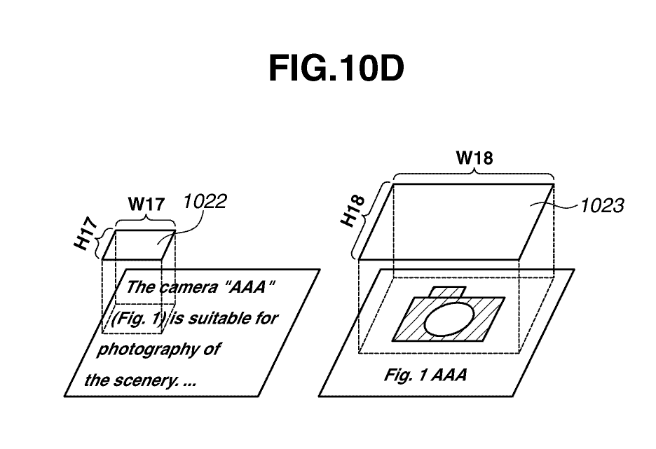

The flowchart illustrated in FIG. 7 includes processing the image data of a plurality of pages having been input by the scanner unit 201 illustrated in FIG. 1, on a page-by-page basis, and converting the processed data into electronic document data including a plurality of pages. In the present exemplary embodiment, the image data of a plurality of pages is, for example, a document illustrated in FIG. 10A that includes a plurality of page images to be designated successively (one by one) as a processing target. Hereinafter, each step of the flowchart illustrated in FIG. 7 is described in detail.

In step S701, the data processing unit 218 initializes the link configuration management tables that are usable to generate link configuration information, which can record a correspondence relationship between an object and an explanatory note describing the object. The link configuration information and the link configuration management tables are described in detail below.

In step S702, the region segmentation unit 301 extracts a region from the input image data corresponding to one page. For example, the region segmentation unit 301 performs region segmentation processing on image data 1001 (the first page) illustrated in FIG. 10A and extracts a region 1006. Further, in step S702, the region segmentation unit 301 identifies information relating to the region 1006, such as “coordinate X”, “coordinate Y”, “width W”, “height H”, and “page” in a data table illustrated in FIG. 10B, and stores these data in the storage unit 211 while associating them with the region 1006.

In step S703, the attribute information allocation unit 302 allocates an attribute to each region divided in step S702 according to the type of the region. For example, according to an example image data 1003 (the third page) illustrated in FIG. 10A, the attribute information allocation unit 302 allocates the attribute “photo” to a region 1009 and the attribute “caption” to a region 1010.

In this case, the attribute information allocation unit 302 adds, to the region 1010, information indicating that the “photo” region 1009 is a target object to which a caption is accompanied. More specifically, the region 1009 becomes a caption accompanied object. As described above, the attribute information allocation unit 302 stores, in the storage unit 211, the “attribute” and “accompanying target object” information illustrated in FIG. 10B in association with each corresponding region.

In step S704, the character recognition unit 303 executes character recognition processing on the region to which the character (e.g., text, caption, heading, or sub-heading) attribute is allocated in step S703. The character recognition unit 303 stores a result of the character recognition processing as character information in the storage unit 211 while associating it with the corresponding region. For example, in step S704, the character recognition unit 303 stores the “character information” illustrated in FIG. 10B as the result of the character recognition processing in the storage unit 211.

In step S705, the link processing unit 304 executes link processing that includes extraction of anchor expression and caption accompanied object, generation of graphic data, and generation of link information. A detailed content of the processing that can be executed by the link processing unit 304 in step S705 is described in detail below with reference to a flowchart illustrated in FIG. 8. If the above-described processing is completed, the processing proceeds to step S706.

The detailed content of the link processing to be performed in step S705 illustrated in FIG. 7 is described below based on an example of input data 1001 to 1005 illustrated in FIG. 10A with reference to the flowchart illustrated in FIG. 8.

[Operation in the Link Processing to be Performed when the First Page (I.E., the Image Data 1001 illustrated in FIG. 10A) is Input]

In step S801 illustrated in FIG. 8, the link information allocation target selection unit 401 of the link processing unit 304 selects one text region of a character region, which is not yet subjected to the link information generation processing, from the region information 411 stored in the storage unit 211.

More specifically, if there is an unprocessed text region (YES in step S801), the link information allocation target selection unit 401 selects the unprocessed text region as a processing target and the processing proceeds to step S802. On the other hand, if there is not any text region (NO in step S801), or if all of the processing is completed, the processing proceeds to step S807.

As the image data 1001 includes the text region 1006, the processing proceeds to step S802.

In step S802, the anchor-in-text expression search unit 403 searches for all specific character strings (e.g., “Fig.”, “Figure”, “Table”, and a combination thereof with a numeral, etc.) of anchor expression that may be extracted through the anchor expression extraction processing performed by the anchor expression extraction unit 402 from the character information 412 corresponding to the text region selected by the link information allocation target selection unit 401 in step S801.

If an anchor expression candidate is detected, the anchor-in-text expression search unit 403 further searches for an explanatory expression candidate that includes the detected anchor expression and describes an object in the text. Then, the processing proceeds to step S803. On the other hand, if no anchor expression candidate is detected, the anchor-in-text expression search unit 403 determines that there is not any corresponding portion to which link information is allocated. Then, the processing returns to step S801.

When the link processing unit 304 processes the image data 1001, the anchor-in-text expression search unit 403 detects a “FIG. 1” region 1007 as an anchor expression candidate from the text region 1006. The anchor-in-text expression search unit 403 stores, in the storage unit 211, “anchor expression candidate” information corresponding to the region 1006 illustrated in FIG. 10B. Further, the anchor-in-text expression search unit 403 stores a sentence including a word “FIG. 1” as an explanatory expression candidate in the storage unit 211 while associating the explanatory expression candidate with the anchor expression candidate. Subsequently, the processing proceeds to step S803.

In step S803, the link information generation unit 404 generates a link identifier and associates the generated link identifier with a region of the anchor expression candidate detected in step S802. The link identifier generated in this step can be used to identify a region to which the link information is allocated.

When the link processing unit 304 processes the image data 1001, the link information generation unit 404 associates a link identifier “text_fig1-1” with the region 1007 existing in the text region 1006. Further, the link information generation unit 404 stores, in the storage unit 211, “link identifier” information corresponding to the region 1006 in the data table illustrated in FIG. 10B. If a plurality of (N) anchor expression candidates similar to “FIG. 1” are present in the text, the link information generation unit 404 associates link identifiers “text_fig1-1” to “text_fig1-N” with these anchor expression candidates, respectively.

In step S804, the link information generation unit 404 generates graphic data and associates the generated graphic data with the link identifier generated in step S803. In this case, the graphic data is graphic drawing information (e.g., a red rectangle) to be used to highlight the position of a link destination target region (i.e., an anchor expression in the text), for example, if a reader clicks an object in a document with a mouse when the reader browses the electronic document data 310 generated in the present exemplary embodiment with an application.

When the link processing unit 304 processes the image data 1001, the link information generation unit 404 associates the link identifier “text_fig1-1” with graphic data (“coordinate X”, “coordinate Y”, “width W”, “height H”)=(“X17”, “Y17”, “W17”, “H17”), as illustrated in a region 1017 of FIG. 10C. Graphic data 1022 illustrated in FIG. 10D is an example of the graphic data. The graphic data 1022 is rectangle information superimposed on the region 1007. The graphic data 1022 is drawing information that can be used to realize a graphic display that enables a user to identify the position of an anchor expression included in an explanatory expression in the text.

More specifically, the graphic data 1022 is drawing information that is usable to simply indicate the position (e.g., paragraph number, row number, etc.) when the reader clicks on a caption accompanied object to move into a page that includes an explanatory expression of the caption accompanied object. As an example of the graphic data, the graphic data 1022 illustrated in FIG. 10D surrounds the anchor expression. However, the graphic data is not limited to the illustrated example.

For example, the graphic data to be generated may not include the position of an anchor expression. It may be desired to generate, as drawing information, graphic data (e.g., a rectangle surrounding a sentence including the anchor expression) indicating the position of an explanatory expression that includes the anchor expression in the text. Further, the graphic data according to the present exemplary embodiment is not limited to a rectangle and can be any other drawing information that can realize an easily understandable highlight display of a shape or a line (e.g., circle, star, arrow, underline, etc.).

In step S805, the link information generation unit 404 generates link information that indicates a link from the anchor expression candidate in the text to an object that is presumed to be present in the document. The link information is a link action setting relating to an operation when a reader of an electronic document according to the present exemplary embodiment makes any action (hereinafter, referred to as a “trigger”) for an explanatory expression in the text (mainly, an anchor expression included in an explanatory expression in the text).

For example, when a reader clicks (as a trigger) an anchor expression region with a mouse, the link information generation unit 404 highlights a graphic corresponding to a link destination object to enable the reader to open a screen of a page that includes the object. Further, in a case where no link destination object is present, the link information generation unit 404 can perform a similar setting.

According to the setting described in FIG. 10C, if no link destination object is present, nothing is to be done (indicated by “-”). Alternatively, it is feasible to display a message indicating that no link destination is present. The above-described link information is described as type of “trigger” and “link action setting” information illustrated in FIG. 10C and stored in the storage unit 211 illustrated in FIG. 2.

In step S806, the link configuration information generation unit 405 updates the link configuration management table that is used to constitute link configuration information that describes a correspondence relationship between an object and an explanatory expression (anchor expression candidate) that describes the object. Updating the link configuration management table makes it feasible to accomplish link information that realizes a mutual link by associating link configuration information to be obtained after completing the final page processing with the trigger and the link action setting having been set in step S805.

FIGS. 9A to 9D illustrate examples of link configuration management tables. The link configuration management table includes a plurality of fields that store the anchor expression candidate and the number of appearances detected in step S802, the link identifier generated in step S803, anchor expression to be extracted in step S808, and link identifier(s) to be generated in step S809, which are stored in the storage unit 211.

An example method for generating a link configuration management table in response to the input of the image data 1001 on the first page is described below with reference to FIGS. 9A to 9D. First, the link configuration information generation unit 405 checks if the anchor character candidate “FIG. 1” detected in step S802 is present in the “anchor expression” field and in the “anchor expression candidate” field.

If an anchor expression or an anchor expression candidate that coincides with the detected anchor character candidate is already present, the link configuration information generation unit 405 determines that the detected anchor character candidate is a link target and additionally registers (additionally records) data relating to the detected anchor character candidate in the existing field.

On the other hand, if there is not any anchor expression (or anchor expression candidate) that coincides with the detected anchor character candidate, the link configuration information generation unit 405 determines that a link destination is undetermined and newly registers data.

At the time when the anchor expression candidate 1007 illustrated in FIG. 10A is detected, there is not any coincidental data. Therefore, the link configuration information generation unit 405 newly generates data 901, and additionally records “FIG. 1” in the “anchor expression candidate” field and “1” in the “number of appearances” field.

Then, the link configuration information generation unit 405 additionally records the link identifier “text_fig1-1” generated in step S803 in the “link identifier” field. As a result, at the time when the processing of the first page is completed, the link configuration management table illustrated in FIG. 9A can be generated and stored in the storage unit 211.

In step S807, the link information allocation target selection unit 401 selects one region (object) that is not yet subjected to the link information generation processing, of the caption accompanied objects, from the region information 411 stored in the storage unit 211. More specifically, if an unprocessed caption accompanied object is present, the link information allocation target selection unit 401 selects the unprocessed caption accompanied object as a processing target. Then, the processing proceeds to step S808.

If there is not any caption accompanied object, or if the processing is thoroughly completed, the link information allocation target selection unit 401 terminates the processing procedure of the flowchart illustrated in FIG. 8. Then, the processing proceeds to step S706 illustrated in FIG. 7.

The image data 1001 of the first page does not include any caption accompanied object. Therefore, the link information allocation target selection unit 401 terminates the processing procedure of the flowchart illustrated in FIG. 8. Then, the processing proceeds to step S706 illustrated in FIG. 7.

In step S706, the format conversion unit 305 performs format conversion processing on the processed data. In step S707, the image processing system transmits the data of the processed page. In step S708, the image processing system determines whether all pages have been processed. If it is determined that there is the next page to be processed (NO in step S708), the processing returns to step S702 in which the region segmentation unit 301 designates an image 1002 of the next page as a processing target and performs the above-described processing on the image 1002.

[Operation in the Link Processing to be Performed when the Second Page (I.E., the Image Data 1002 illustrated in FIG. 10A) is Input]

In step S801, the link information allocation target selection unit 401 selects a text region 1008 from the image data 1002. Then, the processing proceeds to step S802. In step S802, the anchor-in-text expression search unit 403 performs anchor expression candidate detection processing on the text region 1008 of the image data 1002. In this case, the anchor-in-text expression search unit 403 cannot detect any anchor expression candidate. Therefore, the processing returns to step S801 in which it is determined if there is any unprocessed character region.

Then, after the processing of the entire text region is completed, the processing proceeds to step S807. In step S807, the link information allocation target selection unit 401 determines that the image data 1002 does not include any caption accompanied object and terminates the processing procedure of the flowchart illustrated in FIG. 8. Then, the processing proceeds to step S706 illustrated in FIG. 7.

[Operation in the Link Processing to be Performed when the Third Page (I.E., the Image Data 1003 illustrated in FIG. 10A) is Input]

In step S801, the link information allocation target selection unit 401 determines that there is not any text region. Then, the processing proceeds to step S807.

In step S807, the link information allocation target selection unit 401 selects the unprocessed caption accompanied object 1009 from the image data 1003. Then, the processing proceeds to step S808.

In step S808, the anchor expression extraction unit 402 extracts an anchor expression and a caption expression from the character information of a caption region accompanying the caption accompanied object selected by the link information allocation target selection unit 401 in step S807. If an anchor expression is extracted (YES in step S808), the processing proceeds to step S809. If no anchor expression is extracted (NO in step S808), the processing returns to step S807.

In the present exemplary embodiment, the anchor expression is character information (i.e., a character string) that identifies a caption accompanied object. The caption expression is character information (i.e., a character string) that simply describes the caption accompanied object. For example, a caption accompanying the caption accompanied object is constituted by an anchor expression or a caption expression, or may be constituted by a combination thereof or may include none of them.

For example, in many cases, the anchor expression can be constituted by a combination of a specific character string, such as “Fig.” or “Figure”, and a numeral or a symbol. Hence, it is useful to prepare an anchor character string dictionary that stores specific character strings registered beforehand so that a caption expression can be compared with the registered data stored in the dictionary to specify an anchor portion (i.e., an anchor character string+numeral/symbol). Further, it is useful to determine a character string in the caption region other than the anchor expression as a caption expression.

When the link processing unit 304 processes the image data 1003, the anchor expression extraction unit 402 extracts the caption accompanied object 1009. The anchor expression extraction unit 402 extracts an anchor expression and a caption expression from the caption region 1010 accompanying the object 1009. The character information of the caption region 1010 accompanying the caption accompanied object 1009 is “FIG. 1 AAA.” Accordingly, the anchor expression extraction unit 402 identifies “FIG. 1” as an anchor expression and “AAA” as a caption expression. Further, in step S808, the anchor expression extraction unit 402 stores “anchor expression” information corresponding to the caption region 1010 in the storage unit 211, as illustrated in FIG. 10B.

In step S809, the link information generation unit 404 generates a link identifier and associates the generated link identifier with the caption accompanied object selected by the link information allocation target selection unit 401.

When the link processing unit 304 processes the image data 1003 (i.e., the third page), the link information generation unit 404 generates a link identifier “image_fig1-1”, for example, for the caption accompanied object 1009 and associates them with each other using the data table. In this case, as apparent from the data table illustrated in FIG. 10B, the link information generation unit 404 stores “link identifier” information corresponding to the region 1009 in the storage unit 211.

In step S810, the link information generation unit 404 generates graphic data that can identify the object and associates the generated graphic data with the link identifier generated in step S809. The graphic data generated in step S810 is drawing information that can be used to highlight a link target object when an object anchor expression in the text is clicked.

When the link processing unit 304 processes the image data 1003, the link information generation unit 404 associates the link identifier “image_fig1-1” with graphic data (“coordinate X”, “coordinate Y”, “width W”, “height H”)=(“X18”, “Y18”, “W18”, “H18”), as apparent from a region 1018 illustrated in FIG. 10C.

Graphic data 1023 illustrated in FIG. 10D is an example of the graphic data. The graphic data 1023 is rectangle information superimposed on the region 1009. Further, the graphic data according to the present exemplary embodiment is not limited to a rectangle and can be any other drawing information that can realize an easily understandable highlight display of a shape or a line.

In step S811, the link information generation unit 404 generates link information that indicates a link from the caption accompanied object to an explanatory expression (anchor expression) that is present in the text. The link information includes a trigger and a link action setting. Further, the number of link destinations included in an input document is not limited to only one. An input document may include a plurality of link destinations or may not include any link destination.

Hence, the link information generation unit 404 independently performs the link action setting for each of the “no”, “only one”, and “a plurality of” link destinations. For example, in a case where no link destination is present, the link information generation unit 404 “- (does not perform any processing).” In a case where only one link destination is present, the link information generation unit 404 “highlights (with a red color) a corresponding anchor expression in the text+moves to a page including a description of the anchor expression.” In a case where two or more link destinations are present, the link information generation unit 404 “displays a list of pages each including a description of a corresponding anchor expression.”

The link actions to be performed according to the present exemplary embodiment are not limited to the above-described examples. For example, if there is not any link destination, the link information generation unit 404 can display a “message” or an “error” indicating that a moving destination is not present.

Further, if there is a plurality of link destinations, the link information generation unit 404 can display a “message” or an “error” indicating that the presence of a plurality of options with respect to the moving destination. The above-described link information is written as “trigger” and “link action setting” information in the region 1018 illustrated in FIG. 10C and stored in the storage unit 211.

In step S812, the link configuration information generation unit 405 updates the link configuration management table that is usable to constitute a correspondence relationship between an object and an explanatory expression that describes the object.

An example method for updating the link configuration management table in response to input of the image data 1003 is described below with reference to FIGS. 9A to 9D. First, the method includes checking if the anchor character “FIG. 1” detected in step S808 is present in the “anchor expression candidate” field. The link configuration management table illustrated in FIG. 9A includes coincidental data in the “anchor expression candidate” field of the data 901.

Therefore, the link configuration information generation unit 405 additionally records the above-described data. More specifically, the link configuration information generation unit 405 additionally records “FIG. 1” in the “anchor expression” field of the data 901 and the link identifier “text_fig1-1” generated in step S803 in the link identifier field of the data 901. As a result, a link configuration management table illustrated in FIG. 9B can be generated and stored in the storage unit 211.

If the processing of all regions is completed, the link information allocation target selection unit 401 terminates the link processing for the image data 1003. Then, the processing proceeds to step S706 illustrated in FIG. 7.

[Operation in the Link Processing to be Performed when the Fourth Page (I.E., the Image Data 1004 illustrated in FIG. 10A) is Input]

In step S801, the anchor-in-text expression search unit 403 selects a text region 1011. Then, the processing proceeds to step S802.

In step S802, the anchor-in-text expression search unit 403 extracts a character string “FIG. 1” included in the text region 1011 as an anchor expression candidate 1013. Then, the processing proceeds to step S803.

In step S803, the link information generation unit 404 generates a link identifier “text_fig1-2” and stores the generated link identifier while associating it with the anchor expression candidate region 1013 extracted in step S802 (see the field 1011 illustrated FIG. 10B).

In step S804, the link information generation unit 404 generates graphic data to be used to highlight the anchor expression candidate 1013 and associates the generated graphic data with the above-described link identifier (see the field 1019 illustrated in FIG. 10C).

In step S805, the link information generation unit 404 generates link information (e.g., a trigger and a link action setting) for the anchor expression candidate 1013 (see the field 1019 illustrated in FIG. 10C).

In step S806, the link configuration information generation unit 405 updates the link configuration management table. The link configuration information generation unit 405 confirms whether the anchor expression candidate “FIG. 1” detected in step S802 is present in the “anchor expression” field and the “anchor expression candidate” field of the link configuration management tables illustrated in FIGS. 9A to 9D. In this case, a coincidental description is present in the “anchor expression candidate” field of the data 901. Therefore, the link configuration information generation unit 405 increments the number of appearances by one and newly records the link identifier “text_fig1-2.”

Similarly, the link configuration information generation unit 405 repeats the above-described processing of steps S801 to S806 for a text region 1012. FIG. 9C illustrates a link configuration management table that can be obtained when the processing for the image data 1004 of the fourth page is completed.

When the link processing unit 304 processes the image data 1004, in step S807, the link information allocation target selection unit 401 determines that no caption accompanied object is present in the image data 1004 and terminates the processing procedure of the flowchart illustrated in FIG. 8. Then, the processing proceeds to step S706 illustrated in FIG. 7.

[Operation in the Link Processing to be Performed when the Fifth Page (I.E., the Image Data 1005 illustrated in FIG. 10A) is Input]

When the link processing unit 304 processes the image data 1005, in step S801, the anchor-in-text expression search unit 403 selects a text region 1015. Then, the processing proceeds to step S802. In step S802, the anchor-in-text expression search unit 403 detects a character string “FIG. 2” as an anchor expression candidate 1016 in the text region 1015. Then, the processing proceeds to step S803.

In step S803, the link information generation unit 404 generates a link identifier “text_fig2-1” and stores the generated link identifier while associating it with the anchor expression candidate region 1016 extracted in step S802 (see the field 1015 illustrated in FIG. 10B).

In step S804, the link information generation unit 404 generates graphic data to be used to highlight the anchor expression candidate 1016 and associates the generated graphic data with the link identifier “text_fig2-1” (see the field 1021 illustrated in FIG. 10C).

In step S805, the link information generation unit 404 generates link information (i.e., a trigger and a link action setting) for the anchor expression candidate 1016 (see the field 1021 illustrated in FIG. 10C).

In step S806, the link configuration information generation unit 405 updates the link configuration management table. The link configuration information generation unit 405 confirms that the anchor expression candidate “FIG. 2” detected in step S802 is not present in the “anchor expression” field and the “anchor expression candidate” field of the link configuration management tables illustrated in FIGS. 9A to 9D.

Then, the link configuration information generation unit 405 additionally records new link configuration information in a data 902. FIG. 9D illustrates a link configuration management table that can be obtained when the processing for the image data 1005 of the fifth page is completed.

When the link processing unit 304 processes the image data 1005, in step S807, the link information allocation target selection unit 401 determines that no caption accompanied object is present in the image data 1005 and terminates the processing procedure of the flowchart illustrated in FIG. 8. Then, the processing proceeds to step S706 illustrated in FIG. 7.

As described above, in FIG. 8, the processing performed in steps S801 to S806 is for the text region and the processing performed in steps S807 to S812 is for the caption accompanied object. The link information generated by the above-described processing can accomplish a bidirectional link between the “caption accompanied object” and the “anchor expression and the explanatory expression of the object in the text” by using link configuration information (link configuration management table) to be generated after completing the processing for all pages, namely by transmitting the link configuration information in step S709. As described above, the link processing unit 304 can complete the processing of the flowchart illustrated in FIG. 8.

Referring back to FIG. 7, in step S706, the format conversion unit 305 converts the link processed data into the electronic document data 310 based on the image data 300 of the target page to be processed and the information stored in the storage unit 211 illustrated in FIGS. 10B and 10C. As described with reference to FIG. 4, the format conversion unit 305 executes the conversion processing on each region of the image data 300 according to the correspondence table that describes a conversion processing method to be applied to each region.

In the present exemplary embodiment, it is presumed that the format conversion unit 305 performs the conversion processing using the correspondence table illustrated in FIG. 5C. More specifically, for the processing target page image, format converted page data of an electronic document can be generated based on the data illustrated in FIGS. 10B and 10C.

The generated electronic document page includes the data of each converted region of the page, drawing information (graphic data) indicating the position of a link destination, and a link identifier. Further, text search becomes feasible when character information indicating the character recognition result illustrated in FIG. 10B is stored in each page of the electronic document.

In step S707, the data processing unit 218 transmits the format converted electronic document page converted in step S706, on a page-by-page basis, to the client PC 101.

In step S708, the data processing unit 218 determines whether the above-described processing in steps S702 to S707 has been completed for all pages. If it is determined that the processing for all pages has been completed (YES in step S708), the processing proceeds to step S709. If it is determined that there is at least one unprocessed page (NO in step S708), the data processing unit 218 designates the next unprocessed page as a processing target and repeats the above-described processing of steps S702 to S707. As described above, the data processing unit 218 performs the processing of steps S702 to S707 on the image data 1001 to 1005 corresponding to the five pages illustrated in FIG. 10A.

In step S709, the link information output unit 406 performs format conversion based on the link configuration management table (see FIG. 9D) generated in step S705 and the link information of each page illustrated in FIG. 10C and generates link information data (e.g., link configuration information, trigger, and link action setting) of the entire electronic document and then transmits the generated link information data. The link information data is then integrated with the electronic document data of each page, which has a format converted in step S706 and transmitted in step S707, by a transmission destination device.

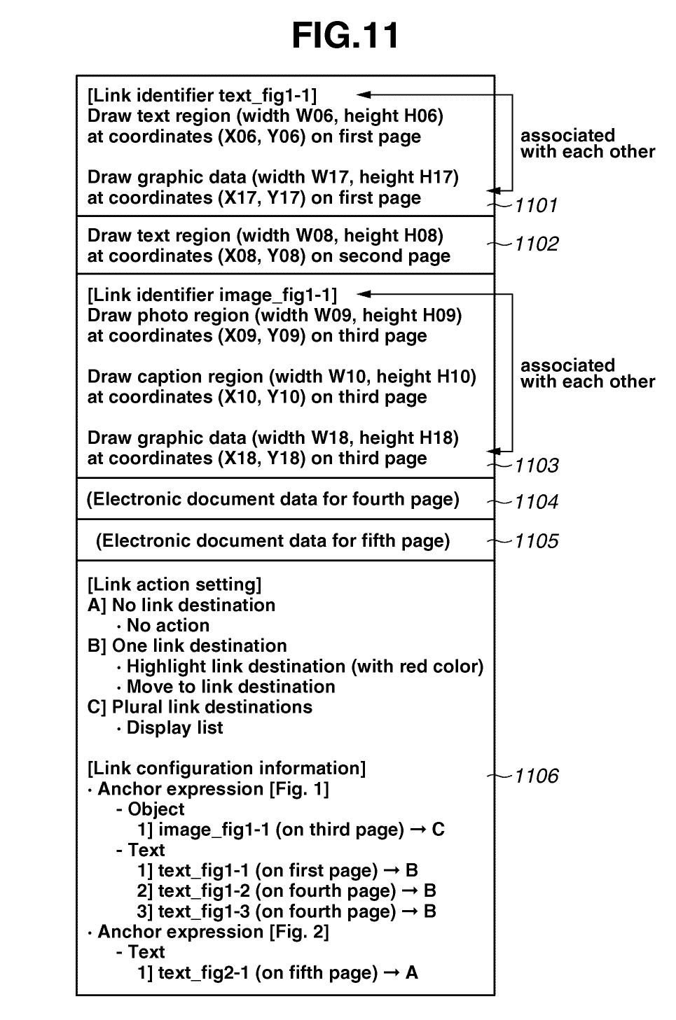

More specifically, as the electronic data of each page is already transmitted in step S707, the link information data is added to the electronic document data by a reception side apparatus (i.e., the client PC 101). FIG. 11 schematically illustrates the electronic document data (the first to fifth pages) and the link information to be transmitted to the client PC 101. The electronic document data illustrated in FIG. 11 includes electronic document data 1101 to 1105, corresponding to the first to fifth pages, and link information data 1106.

The link information data 1106 includes link configuration information relating to the anchor expression “FIG. 1”, indicating that the object link identifier “image_fig1-1” is linked with the link identifiers “text_fig1-1”, “text_fig1-2”, and “text_fig1-3”, which are anchor expression candidates extracted from the text.

Further, if the object “image_fig1-1” is clicked, a list of a plurality of link destinations can be displayed to indicate that a user can select a desired one of the link destinations. Further, if any one of the anchor expression candidates “text_fig1-1”, “text_fig1-2”, and “text_fig1-3” in the text is clicked, a graphic corresponding to the mutually linked object is highlighted to instruct to open a page to display the link destination object. As described above, the data processing unit 218 can complete the processing of the flowchart illustrated in FIG. 7.

In the above-described exemplary embodiment, the processing of the flowchart illustrated in FIGS. 7 and 8 is executed by the data processing unit 218 (more specifically, the processing units 301 to 305 illustrated in FIG. 3) illustrated in FIG. 2. The CPU 205 according to the present exemplary embodiment is functionally operable as the data processing unit 218 (i.e., the processing units 301 to 305 illustrated in FIG. 3).

To this end, the CPU 205 reads a computer program from the storage unit 211 (i.e., a computer readable storage medium) and executes the readout program. However, the data processing unit 218 is not limited to the CPU 205. For example, an appropriate electronic circuit or any other hardware is employable as the data processing unit 218 (i.e., the processing units 301 to 305 illustrated in FIG. 3).

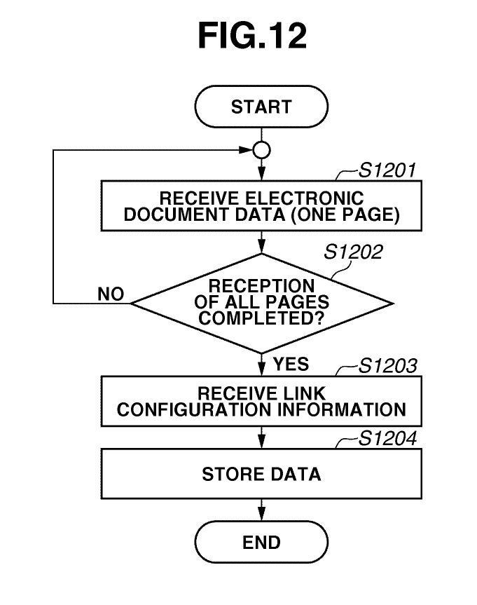

Subsequently, example processing that can be executed by a reception side apparatus is described below with reference to a flowchart illustrated in FIG. 12. The client PC 101 (i.e., the reception side apparatus) receives the electronic document data transmitted from the MFP 100 (i.e., the transmission side apparatus) on a page-by-page basis and finally receives the link information data.

First, in step S1201, the client PC 101 receives the electronic document data (of each page) transmitted in step S707 illustrated in FIG. 7, i.e., successively receives the page data starting with the image data 1001.

Next, in step S1202, the client PC 101 determines whether the electronic document data of all pages has been thoroughly received. If the electronic document data of all pages has been already received (YES in step S1202), the processing proceeds to step S1203. If there is any electronic document data not yet received (NO in step S1202), the processing returns to step S1201, in which the client PC 101 receives the data relating to the next page.

Next, in step S1203, the client PC 101 receives the link configuration information, which is the data transmitted in step S709 illustrated in FIG. 7.

Finally, in step S1204, the client PC 101 combines the electronic document data (i.e., the first to fifth pages) received in step S1201 with the link information data received in step S1203 and stores the combined data in a storage region (not illustrated) of the client PC 101. In the present exemplary embodiment, the client PC 101 stores the combined data as an electronic document file composed of multiple pages.

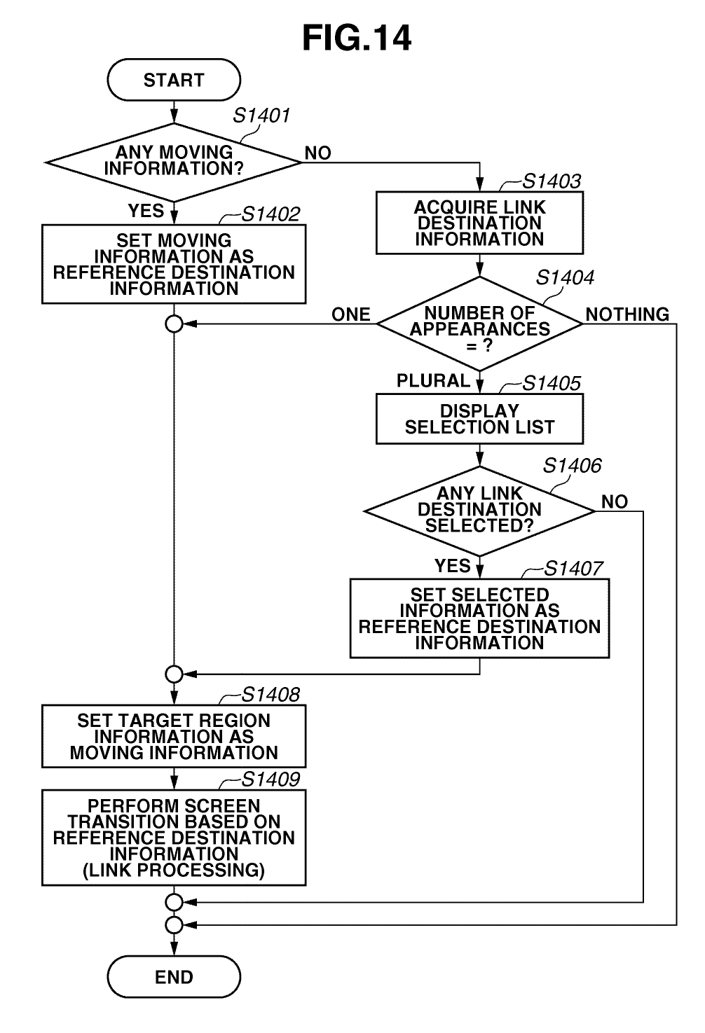

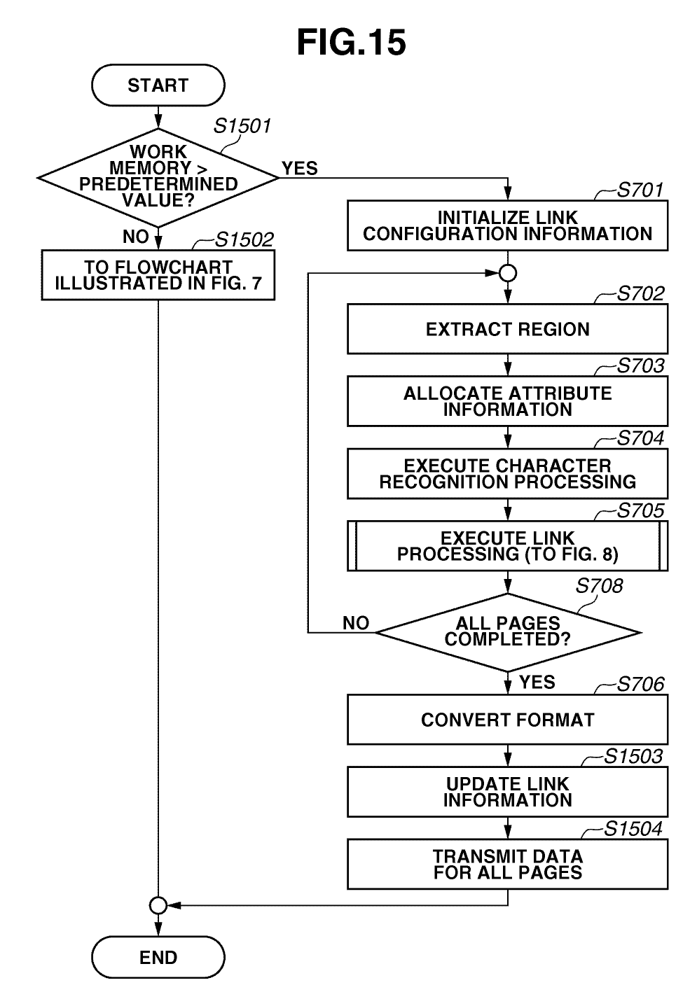

Next, an example operation that can be executed by an application to realize a mutual link based on a description of the electronic document data according to the present exemplary embodiment is described below with reference to the flowchart illustrated in FIG. 14. In the present exemplary embodiment, the application executes the processing of the flowchart illustrated in FIG. 14 each time a user clicks at the portion of a desired anchor expression or object application on a displayed screen of the electronic document data.

In step S1401, the application checks if the link information for the clicked object (or anchor expression) is temporarily associated with moving information. If it is determined that the link information is associated with the moving information (YES in step S1401), the processing proceeds to step S1402. On the other hand, if it is determined that the link information is not associated with the moving information (NO in step S1401), the processing proceeds to step S1403.

In the present exemplary embodiment, the moving information is usable in the transition from a link source anchor expression to a page including a link destination object, if the link destination object is clicked, to return to the page including the former (before transition) link source anchor expression.

For example, it is now assumed that a reader clicks one of a plurality of anchor expressions and a transition from the link source anchor expression to the page including the link destination object is generated based on the link information. In this case, the information relating to the clicked link source anchor expression is temporarily stored as moving information while it is associated with the link destination object.

It is desired to configure the system in such a way as to return to the transition source page, if the reader clicks the link destination object after completing browsing, by referring to the moving information associated with the object so that the link source anchor expression (in the state before transition to the object page) can be displayed.

For example, if the reader wants to confirm an object corresponding to the anchor expression “FIG. 1” in the image data 1001 (i.e., the first page) illustrated in FIG. 10A, the reader clicks the region 1007 included in the anchor expression. The link configuration information and the link action setting of the anchor expression are referred to if the click is detected. Then, the object region 1009 of the image data 1003 (the third page) associated with the anchor expression is highlighted with a red color and the page including the object is opened.

In this case, the information relating to the clicked anchor expression (e.g., the link identifier or the positional information) is temporarily stored as moving information while it is associated with the linked object 1009. Subsequently, if the reader clicks the object region 1009, the processing of the temporarily stored moving information is prioritized over the processing of the link information associated with the object region, so that the anchor expression of the previously displayed page can be restored.

In step S1402, the application sets the stored content of the moving information as reference destination information (i.e., link destination information). Thus, if the clicked object (or anchor expression) is the one displayed based on page transition, the processing returns to the place (i.e., link source information) having been browsed immediately before and the information is set as a reference destination.

In step S1403, the application acquires link destination information associated with the clicked object (or anchor expression) from the link configuration information generated in step S705 and transmitted in step S709 illustrated in FIG. 7. For example, in a case where the object region 1009 in the image data 1003 is clicked, the application can acquire a link identifier (or relevant information) of an anchor expression candidate linked to the object region 1009 with reference to the link information data 1106 illustrated in FIG. 11 (i.e., the content of the link configuration management table illustrated in FIG. 9D). In this case, the application can acquire three link identifiers (i.e., “text_fig1-1”, “text_fig1-2”, and “text_fig1-3”) relating to the anchor expression candidate “FIG. 1” in the text that corresponds to the object region 1009.

In step S1404, the application selects processing to be performed next considering the number of the link destinations. If no link destination is present, the application does not perform any processing and terminates the processing procedure of the flowchart illustrated in FIG. 14. Further, if only one link destination is present, the application sets the link destination as reference destination information (i.e., link destination information) and the processing proceeds to step S1408. Further, if two or more link destinations are present, the processing proceeds to step S1405.

In step S1405, the application displays a selection list to enable the reader to select a desired link destination from the plurality of link destinations. More specifically, the application displays a list of the link destinations (i.e., “anchor expression candidates (explanatory note for the object)”) acquired in step S1403 so that each user can select a desired candidate.

In step S1406, the application determines whether the reader has selected a link destination from the selection list. If it is determined that no link destination has been selected (NO in step S1406), the application terminates the processing procedure of the flowchart illustrated in FIG. 14. If it is determined that a desired link destination has been selected (YES in step S1406), the processing proceeds to step S1407.

In step S1407, the application sets information corresponding to the item selected from the selection list, such as the link identifier or the positional information, as reference destination information (i.e., link destination information).

In step S1408, the application acquires information relating to the place where the reader browses (i.e., the clicked object (or anchor expression)) and performs setting in such a way as to temporarily hold the acquired information as moving information while associating it with the link destination.

In step S1409, the application performs link processing with reference to the reference destination information having been set in step S1402 or S1407 and a content of the link action setting relating to the clicked object (or anchor expression). For example, in a case where only one link destination is present, the application highlights graphic data of the link destination with a red color and performs screen transition in such a manner that the highlighted region of the link destination can be immediately found.

The application performs the above-described operation when the application browses electronic document data. In the present exemplary embodiment, an example operation based on the link action having been set in step S805 and step S811 illustrated in FIG. 8 (see FIG. 10C) has been described. If a link action different from the link action illustrated in FIG. 10C is set, the processing procedure may be slightly changed.

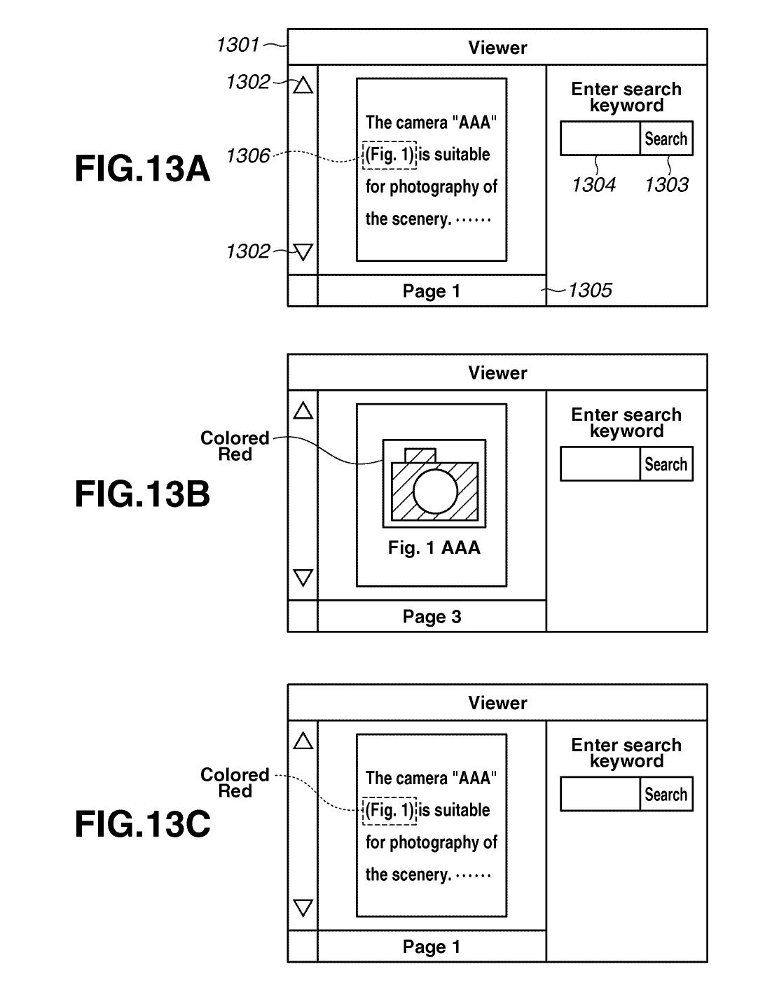

Next, an example operation that can be executed when a document reader uses an application to browse electronic document data generated according to the present exemplary embodiment is described in detail below with reference to FIGS. 13A to 13C.

FIGS. 13A to 13C illustrate examples of a virtual GUI software display screen that can be executed by the client PC 101 illustrated in FIG. 1 or another client PC when as an application is launched to browse electronic document data includes link information. An actual example of such an application is Adobe Reader®. The type of the application is not limited to the above-described one. For example, any other application having the capability of realizing a display operation on the operation unit 203 of the MFP 100 is employable. If the application is Adobe Reader®, the format of the data illustrated in FIG. 6 is required to be PDF.

FIG. 13A illustrates a display screen 1301 of an application that can be launched to browse the above-described electronic data. An example electronic document on the display screen 1301 is the first page (i.e., link information generated page) illustrated in FIG. 10A in the present exemplary embodiment). The display screen 1301 includes a page scroll button 1302 that a reader can press with a mouse to display a preceding page or a following page. The display screen 1301 further includes a window 1304 that enables the reader to enter a search keyword, a search execution button 1303 that can be pressed to execute a search based on the input search keyword, and a status bar 1305 that indicates a page number of the presently displayed page.

According to a conventional technique, when a reader browses electronic document data and finds a drawing (e.g., “FIG. 1”) referred to by an anchor expression 1306, the reader generally presses the page scroll button 1302 or enters a search keyword “FIG. 1” in the window 1304. Then, the reader browses the drawing referred to by the anchor expression. For example, if the content of the drawing is confirmed, the reader presses the page scroll button 1302 to return to the first page and reads a subsequent sentence.

On the other hand, if a reader browses electronic document data including link information according to the present exemplary embodiment, the reader clicks with a mouse on the region including the anchor expression 1306 illustrated in FIG. 13A. If the region is clicked, link information of the region 1014 illustrated in FIG. 10C is referred to and the object referred to by the anchor expression “FIG. 1”, more specifically, a caption accompanied region (graphic data) is highlighted with a red color. Then, the page including the caption accompanied region is opened, as illustrated in FIG. 13B.

More specifically, the caption accompanied region is highlighted with a red rectangle and the third page is opened. Next, the reader browses the caption accompanied region, and after confirming the content of the region, the reader clicks with the mouse on the caption accompanied region illustrated in FIG. 13B. If the click is executed, the application highlights the anchor expression (graphic data) with a red color with reference to the moving information (or link information) associated with the region 1015 illustrated in FIG. 10A and opens the page including the anchor expression.

In the present exemplary embodiment, FIG. 13B illustrates a result of screen transition from page 1 to page 3. Therefore, the moving information is present. If the caption accompanied object is clicked, the anchor expression of page 1 designated by the moving information is displayed as illustrated in FIG. 13C. More specifically, FIG. 13C illustrates the anchor expression highlighted with a red rectangle on the reopened first page.

As described above, the processing according to the present exemplary embodiment includes generating link information added electronic document data on a page-by-page basis, updating the link configuration management table, and successively transmitting the generated page information for each page. Then, if the processing is completed for all pages, the finally obtained link configuration information is used to generate a mutual link between the “object” and the “anchor expression and the explanatory expression of the object in the text.” In this case, the “object” may not be in a one-to-one relationship with the “explanatory expression of the object.” In such a case, it is useful to define a plurality of link actions.

According to the present exemplary embodiment, when a document image of a plurality of pages is transmitted to a PC, a mutual link can be easily realized through the page-by-page basis processing even when the page including the “object” is different from the page including the “anchor expression and the explanatory expression of the object in the text.”

Further, transmitting the generated electronic document data on a page-by-page basis is useful because the required memory can be reduced and the transfer efficiency can be improved, compared to a case where the electronic document data of all pages is generated and transmitted together. For example, a work memory of 2 M bytes is conventionally required to process the document image constituted by five pages illustrated in FIG. 10A. On the other hand, according to the present exemplary embodiment, it is feasible to reduce the required memory size to 400K bytes.

In the first exemplary embodiment, the target extracted by the anchor expression extraction unit 402 and the anchor-in-text expression search unit 403 for the link information generation processing is limited to only the anchor character (e.g., “FIG. 1”, “FIG. 1”, etc.).

In a second exemplary embodiment of the present invention, the character string to be extracted is not limited to the anchor character. The target for the link information generation can be a character string that is frequently used in the text and a character string designated by a user (e.g., a keyword). Further, a pair of targets constituting a link is not limited to a combination of an “object” and an “explanatory note for the object.” For example, a link between two “explanatory notes for an object” can be a pair of link targets. In this case, an effect of enabling a reader to read relevant portions only can be obtained.

In the first and second exemplary embodiments, the document data input as the image data 300 by the scanner unit 201 is a paper document including an “object” and an “explanatory note for the object.” The electronic document data 310 including bidirectional link information is generated. However, the input document is not limited to a paper document and can be an electronic document.

More specifically, in a third exemplary embodiment of the present invention, it is feasible to input an electronic document of SVG, XPS, PDF, or OfficeOpenXML that does not include bidirectional link information and generate an electronic document data including bidirectional link information. If the input document is an electronic document, the raster image processor (RIP) 213 illustrated in FIG. 2 analyzes a page description language (PDL) code and rasterizes the electronic document into a bitmap image having a designated resolution. In other words, the RIP 213 realizes so-called rendering processing.

When the above-described rasterizing processing is performed, attribute information is allocated on a pixel-by-pixel basis or on a region-by-region basis. This is generally referred to as image region determination processing. When the image region determination processing is performed, attribute information indicating the type of an object, such as text, line, graphics, or image, can be allocated to each pixel or each region.

For example, the RIP 213 outputs an image region signal according to the type of a PDL description object in a PDL code. Attribute information according to an attribute indicated by the signal value is stored in association with a pixel or a region corresponding to the object. Accordingly, associated attribute information is added to the image data.

Further, both a character string described in a region to which a character attribute is allocated and a character string described in a region to which a table attribute is allocated include a character code in the PDL description. Therefore, they can be associated with each other.

More specifically, if an input electronic document already includes region information (e.g., position, size, and attribute) and character information, the processing to be performed by the region segmentation unit 301, the attribute information allocation unit 302, and the character recognition unit 303 can be omitted to improve the processing efficiency.

In the first to third exemplary embodiments, the method for generating a PDF file of multiple pages while realizing a mutual link between an “object” and an “explanatory note for the object” in such a way as to reduce the required memory size and lower the transfer efficiency has been described.

In a fourth exemplary embodiment of the present invention, the link information generation processing is adaptively switchable in such a way as to generate link information after completing the data processing of all pages if a work memory is sufficiently available to hold pages and generate link information for each page if the available work memory is insufficient.

Hereinafter, an example method for switching the link information generation processing between a first case where the work memory is sufficiently available to hold pages and a second case where the available work memory is insufficient is described below with reference to a flowchart illustrated in FIG. 15. It is now assumed that the image data 1001 to 1005 illustrated in FIG. 10A are input as image data of a plurality of pages. In FIG. 15, steps similar to those already described with reference to FIG. 7 in the first exemplary embodiment are denoted by the same step numbers and the descriptions thereof are not repeated.

First, in step S1501, it is determined whether the work memory available to hold pages is greater than a predetermined value. More specifically, a counter (not illustrated) counts the number of a plurality of document sheets that are placed on the image reading unit 110 of the MFP 100 to calculate a required work memory capacity to hold all pages. Then, it is determined whether the calculated memory capacity can be provided by the storage unit 111 of the MFP 100. Alternatively, a sensor (not illustrated) of an auto document feeder (ADF) included in the image reading unit 110 is usable to count the number of the document sheets to be read. Moreover, a user can manually input the number of the document sheets via a user interface (not illustrated).

If it is determined that the available work memory is equal to or less than the predetermined value (NO in step S1501), the processing proceeds to step S1502. Processing to be executed subsequently is similar to the processing performed in the flowchart illustrated in FIG. 7 and electronic document data similar to that obtained in the second exemplary embodiment can be generated.

If it is determined that the available work memory is greater than the predetermined value (YES in step S1501), the processing proceeds to step S701. Processing to be executed in steps S702 to S706 and step S708 is similar to the processing described in the first exemplary embodiment. Therefore, the description thereof is not repeated. However, in the first exemplary embodiment, the format conversion unit 305 has performed the page-by-page basis format conversion processing in step S706. On the other hand, in the present exemplary embodiment, the format conversion unit 305 converts the data of all pages into electronic document data in a batch fashion.

In step S1503, the link information generation unit 404 updates the link information based on a link configuration management table generated after the processing of all pages is completed. More specifically, the link information generation unit 404 can delete unnecessary processing setting that has been set as a link action according to the number of link destinations. Further, if no link destination is present, the link information generation unit 404 can delete the link information itself. The link information generated in the above-described manner can be compressed into minimum required information. In other words, the size of a generated file can be reduced.

In step S1504, the data processing unit 218 transmits the format converted electronic document data to the client PC 101 and terminates the processing procedure of the flowchart illustrated in FIG. 15.

Through the above-described processing, the file size of generated electronic document data can be reduced by restricting a link action to be allocated to each link information if a work memory is sufficiently available to hold pages. Further, limiting the processing in a link operation to only the required one is useful to improve the viewer performance in browsing.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-156008 filed Jul. 8, 2010, which is hereby incorporated by reference herein in its entirety.

What is claimed is:

1. An image processing apparatus comprising:
an input unit configured to input a document including a plurality of page images;
a region segmentation unit configured to divide each page image input by the input unit into attribute regions;
a character recognition unit configured to execute character recognition processing on the regions divided by the region segmentation unit;
a first detection unit configured to detect a first anchor expression constituted by a specific character string from a result of the character recognition processing executed by the character recognition unit on a text attribute region in the page image;
a first identifier allocation unit configured to allocate a first link identifier to the first anchor expression detected by the first detection unit;
a first graphic data generation unit configured to generate graphic data to be used to identify the first anchor expression detected by the first detection unit and associate the generated graphic data with the first link identifier allocated by the first identifier allocation unit;
a first table updating unit configured to register the first link identifier and the first anchor expression in a link configuration management table while associating them with each other and, if an anchor expression similar to the first anchor expression is already registered in the link configuration management table, configured to update the link configuration management table in such a way as to mutually associate the link identifiers of the same anchor expression;
a second detection unit configured to detect a second anchor expression constituted by a specific character string from a result of the character recognition processing executed by the character recognition unit on a caption region accompanying an object in the page image;
a second identifier allocation unit configured to allocate a second link identifier to the object accompanied by the caption region where the second anchor expression is detected;
a second graphic data generation unit configured to generate graphic data to be used to identify the object accompanied by the caption region where the second anchor expression is detected and associate the generated graphic data with the second link identifier allocated by the second identifier allocation unit;
a second table updating unit configured to register the second link identifier and the second anchor expression in the link configuration management table while associating them with each other and, if an anchor expression similar to the second anchor expression is already registered in the link configuration management table, configured to update the link configuration management table in such a way as to mutually associate the link identifiers of the same anchor expression;
a page data generation unit configured to generate page data of an electronic document for the page image, using the first link identifier, the first graphic data, the second link identifier, and the second graphic data;
a first transmission unit configured to transmit the page data of the electronic document generated by the page data generation unit;
a control unit configured to successively designate each page of the page image input by the input unit as a processing target and control processing repetitively executed by the region segmentation unit, the character recognition unit, the first detection unit, the first identifier allocation unit, the first graphic data generation unit, the first table updating unit, the second detection unit, the second identifier allocation unit, the second graphic data generation unit, the second table updating unit, the page data generation unit, and the first transmission unit; and
a second transmission unit configured to generate link configuration information to be used to link the first link identifier with the second link identifier included in the electronic document based on the link configuration management table updated by the first table updating unit and the second table updating unit, and configured to transmit the generated link configuration information.

2. The image processing apparatus according to claim 1, wherein the object includes anyone of table, line drawing, and photo attribute regions.

3. The image processing apparatus according to claim 1, wherein the page data generation unit is configured to execute format conversion processing to generate the page data of the electronic document.

4. The image processing apparatus according to claim 1, wherein the page data of the electronic document transmitted by the first transmission unit is integrated with the link configuration information transmitted by the second transmission unit by a transmission destination apparatus.

5. The image processing apparatus according to claim 1, wherein the specific character string is a character string including “figure”, “FIG”, or “table.”

6. The image processing apparatus according to claim 1, further comprising:
a determination unit configured to determine whether a work memory required to process all of the plurality of page images that constitute the document is available,
wherein, if the determination unit determines that the work memory is not available, each page of the page image input by the input unit is successively designated as a processing target and the processing by the region segmentation unit, the character recognition unit, the first detection unit, the first identifier allocation unit, the first graphic data generation unit, the first table updating unit, the second detection unit, the second identifier allocation unit, the second graphic data generation unit, the second table updating unit, the page data generation unit, the first transmission unit, the control unit, and the second transmission unit is executed, and
wherein, if the determination unit determines that the work memory is available, the processing by the region segmentation unit, the character recognition unit, the first detection unit, the first identifier allocation unit, the first graphic data generation unit, the first table updating unit, the second detection unit, the second identifier allocation unit, the second graphic data generation unit, and the second table updating unit is executed on the plurality of page images input by the input unit, and then control is performed to generate page data and link information corresponding to all pages and transmit the generated page data and link information.

7. An image processing apparatus comprising:
an input unit configured to input a document including a plurality of page images;
a region segmentation unit configured to divide each page image input by the input unit into attribute regions;
a character recognition unit configured to execute character recognition processing on the regions divided by the region segmentation unit;
a detection unit configured to detect an anchor expression constituted by a specific character string from a result of the character recognition processing executed by the character recognition unit;
an identifier allocation unit configured to allocate a link identifier to the anchor expression detected by the detection unit;
a generation unit configured to generate data that associates a highlight position to be determined based on the anchor expression with the link identifier;
a table updating unit configured to register the anchor expression and the link identifier in a link configuration management table while associating them with each other and, if an anchor expression similar to the anchor expression is already registered in the link configuration management table, configured to update the link configuration management table in such a way as to mutually associate the link identifiers of the same anchor expression;
a first transmission unit configured to generate page data of an electronic document for the page image, based on the link identifier and the highlight position, and transmit the generated page data;
a control unit configured to successively designate each page of the page image input by the input unit as a processing target and control processing repetitively executed by the region segmentation unit, the character recognition unit, the detection unit, the identifier allocation unit, the generation unit, the table updating unit, and the first transmission unit; and
a second transmission unit configured to generate link configuration information to be used to link the link identifiers included in the electronic document based on the link configuration management table updated by the table updating unit, and configured to transmit the generated link configuration information.

8. An image processing method comprising:
inputting a document including a plurality of page images;
dividing each input page image into attribute regions;
executing character recognition processing on the divided regions;
detecting a first anchor expression constituted by a specific character string from a result of the character recognition processing executed on a text attribute region in the page image;
allocating a first link identifier to the detected first anchor expression;
generating graphic data to be used to identify the detected first anchor expression and associating the generated graphic data with the allocated first link identifier;
registering the first link identifier and the first anchor expression in a link configuration management table while associating them with each other and, if an anchor expression similar to the first anchor expression is already registered in the link configuration management table, updating the link configuration management table in such a way as to mutually associate the link identifiers of the same anchor expression;
detecting a second anchor expression constituted by a specific character string from a result of the character recognition processing executed on a caption region accompanying an object in the page image;
allocating a second link identifier to the object accompanied by the caption region where the second anchor expression is detected;
generating graphic data to be used to identify the object accompanied by the caption region where the second anchor expression is detected and associating the generated graphic data with the allocated second link identifier;
registering the second link identifier and the second anchor expression in the link configuration management table while associating them with each other and, if an anchor expression similar to the second anchor expression is already registered in the link configuration management table, updating the link configuration management table in such a way as to mutually associate the link identifiers of the same anchor expression;
generating page data of an electronic document for the page image, using the first link identifier, the first graphic data, the second link identifier, and the second graphic data;
transmitting the generated page data of the electronic document;
successively designating each page of the input page image as a processing target and controlling the region division processing, the character recognition processing, the first anchor expression detection processing, the first link identifier allocation processing, the first graphic data generation processing, the first table updating processing, the second anchor expression detection processing, the second link identifier allocation processing, the second graphic data generation processing, the second table updating processing, the page data generation processing, and the page data transmission processing, which are repetitively executed; and
generating link configuration information to be used to link the first link identifier with the second link identifier included in the electronic document based on the updated link configuration management table, and transmitting the generated link configuration information.

9. An image processing method comprising:
inputting a document including a plurality of page images;
dividing each page image input by the input unit into attribute regions;
executing character recognition processing on the divided regions;
detecting an anchor expression constituted by a specific character string from a result of the executed character recognition processing;
allocating a link identifier to the detected anchor expression;
generating data that associates a highlight position to be determined based on the anchor expression with the link identifier;
registering the anchor expression and the link identifier in a link configuration management table while associating them with each other and, if an anchor expression similar to the anchor expression is already registered in the link configuration management table, updating the link configuration management table in such a way as to mutually associate the link identifiers of the same anchor expression;
generating page data of an electronic document for the page image, based on the link identifier and the highlight position, and transmitting the generated page data;
successively designating each input page of the page image as a processing target and controlling the region division processing, the character recognition processing, the anchor expression detection processing, the identifier allocation processing, the generation processing, the table updating processing, and the page data transmission processing, which are repetitively executed; and
generating link configuration information to be used to link the link identifiers included in the electronic document based on the updated link configuration management table, and transmitting the generated link configuration information.

10. A non-transitory computer-readable storage medium that stores a computer program, in which the computer program comprises:
computer-executable instructions for causing an input unit to input a document including a plurality of page images;
computer-executable instructions for causing a region segmentation unit to divide each page image input by the input unit into attribute regions;
computer-executable instructions for causing a character recognition unit to execute character recognition processing on the regions divided by the region segmentation unit;
computer-executable instructions for causing a first detection unit to detect a first anchor expression constituted by a specific character string from a result of the character recognition processing executed by the character recognition unit on a text attribute region in the page image;
computer-executable instructions for causing a first identifier allocation unit to allocate a first link identifier to the first anchor expression detected by the first detection unit;
computer-executable instructions for causing a first graphic data generation unit to generate graphic data to be used to identify the first anchor expression detected by the first detection unit and associate the generated graphic data with the first link identifier allocated by the first identifier allocation unit;
computer-executable instructions for causing a first table updating unit to register the first link identifier and the first anchor expression in a link configuration management table while associating them with each other and, if an anchor expression similar to the first anchor expression is already registered in the link configuration management table, update the link configuration management table in such a way as to mutually associate the link identifiers of the same anchor expression;
computer-executable instructions for causing a second detection unit to detect a second anchor expression constituted by a specific character string from a result of the character recognition processing executed by the character recognition unit on a caption region accompanying an object in the page image;
computer-executable instructions for causing a second identifier allocation unit to allocate a second link identifier to the object accompanied by the caption region where the second anchor expression is detected;
computer-executable instructions for causing a second graphic data generation unit to generate graphic data to be used to identify the object accompanied by the caption region where the second anchor expression is detected and associate the generated graphic data with the second link identifier allocated by the second identifier allocation unit;
computer-executable instructions for causing a second table updating unit to register the second link identifier and the second anchor expression in the link configuration management table while associating them with each other and, if an anchor expression similar to the second anchor expression is already registered in the link configuration management table, update the link configuration management table in such a way as to mutually associate the link identifiers of the same anchor expression;
computer-executable instructions for causing a page data generation unit to generate page data of an electronic document for the page image, using the first link identifier, the first graphic data, the second link identifier, and the second graphic data;
computer-executable instructions for causing a first transmission unit to transmit the page data of the electronic document generated by the page data generation unit;
computer-executable instructions for causing a control unit to successively designate each page of the page image input by the input unit as a processing target and control processing repetitively executed by the region segmentation unit, the character recognition unit, the first detection unit, the first identifier allocation unit, the first graphic data generation unit, the first table updating unit, the second detection unit, the second identifier allocation unit, the second graphic data generation unit, the second table updating unit, the page data generation unit, and the first transmission unit; and
computer-executable instructions for causing a second transmission unit to generate link configuration information to be used to link the first link identifier with the second link identifier included in the electronic document based on the link configuration management table updated by the first table updating unit and the second table updating unit, and transmit the generated link configuration information.

11. A non-transitory computer-readable storage medium that stores a computer program, in which the computer program comprises:
computer-executable instructions for causing an input unit to input a document including a plurality of page images;
computer-executable instructions for causing a region segmentation unit to divide each page image input by the input unit into attribute regions;
computer-executable instructions for causing a character recognition unit to execute character recognition processing on the regions divided by the region segmentation unit;
computer-executable instructions for causing a detection unit to detect an anchor expression constituted by a specific character string from a result of the character recognition processing executed by the character recognition unit;
computer-executable instructions for causing an identifier allocation unit to allocate a link identifier to the anchor expression detected by the detection unit;
computer-executable instructions for causing a generation unit to generate data that associates a highlight position to be determined based on the anchor expression with the link identifier;
computer-executable instructions for causing a table updating unit to register the anchor expression and the link identifier in a link configuration management table while associating them with each other and, if an anchor expression similar to the anchor expression is already registered in the link configuration management table, update the link configuration management table in such a way as to mutually associate the link identifiers of the same anchor expression;
computer-executable instructions for causing a first transmission unit to generate page data of an electronic document for the page image, based on the link identifier and the highlight position, and transmit the generated page data;
computer-executable instructions for causing a control unit to successively designate each page of the page image input by the input unit as a processing target and control processing repetitively executed by the region segmentation unit, the character recognition unit, the detection unit, the identifier allocation unit, the generation unit, the table updating unit, and the first transmission unit; and
computer-executable instructions for causing a second transmission unit to generate link configuration information to be used to link the link identifiers included in the electronic document based on the link configuration management table updated by the table updating unit, and transmit the generated link configuration information.
